(19) United States
(12) Patent Application Publication
(10) Pub. No.: US 2025/0369799 A1
(43) Pub. Date: Dec. 4, 2025

(54) BACKGROUND-BASED CORRECTION OF PHOTODETECTOR DRIFT

(71) Applicant: TRINAMIX GMBH, Ludwigshafen Am Rhein (DE)

(72) Inventors: Henning ZIMMERMANN, Ludwigshafen am Rhein (DE); Michael HANKE, Ludwigshafen am Rhein (DE)

(21) Appl. No.: 18/874,328

(22) PCT Filed: Jul. 13, 2023
(86) PCT No.: PCT/EP2023/069480

§ 371 Date: Dec. 12, 2024

(30) Foreign Application Priority Data
Jul. 14, 2022 (EP) 22184881.5

(51) Int. Cl. G01J 3/02; G01J 1/30; G01J 1/44

(52) U.S. Cl. CPC G01J 3/0297; G01J 1/30; G01J 1/44; G01J 2001/444

(57) ABSTRACT

Disclosed herein is a method for determining at least one correction function for compensating for responsivity changes of at least one photodetector. The photodetector includes at least one photosensitive region and at least one readout electronics unit for reading out the photosensitive region. The method includes the following steps:
a) determining at least one reference signal of the photodetector, wherein the photosensitive region is illuminated by optical radiation provided by at least one reference for determining the reference signal;
b) determining at least one background signal level of the photodetector; and
c) determining the correction function by using at least one evaluation unit.

Also disclosed herein are a method for determining at least one item of information on at least one measurement object, a photodetector and a spectrometer.

### TECHNICAL FIELD

The invention relates to a method for determining at least one correction function for compensating for responsivity changes of at least one photodetector, a method for determining at least one item of information on a measurement object using at least one photodetector, a photodetector and a spectrometer. Such methods and devices can, in general, be used for investigation or monitoring purposes, in particular in the infrared (IR) spectral region, especially in the near-infrared (NIR) spectral region, as well as for a detection of heat, flames, fire, or smoke. However, further kinds of applications are possible.

### BACKGROUND ART

Optical spectroscopic methods, specifically in the near- and mid-infrared spectral range, allow an insight into a molecular structure of an object by observing vibrations of molecular bonds. While mid-infrared light can be used to excite fundamental vibrational modes having high finesse and absorption strengths, the near-infrared spectral range enables an observation of higher modes (overtones) and combination bands at lower absorption strengths. These advantages may enable to probe bulk objects and to obtain information on molecular constituents by using near-infrared spectroscopy. As a result, NIR spectroscopy can be widely applied in life and natural sciences, medicine, material science, agriculture, food, or pharmaceutical industries, e.g., for blood sugar measurements, pulse oximetry, fat content, material classification, product fraud identification, and many others.

However, providing analytical devices for the NIR wavelength range is, typically, rather difficult compared to spectrometers operating in visible light: Silicon-based light detectors are typically not applicable for light having a wavelength above 1.1 μm due to the band structure. However, indium, germanium, or lead salts or thermopiles can be applied. NIR detectors in laboratory spectrometers as well as in benchtop spectrometers are, typically, thermo-electrically cooled, often by using multiple stages, especially in order to achieve low temperatures, high detectivity and stabilization towards temperature drifts. However, thermo-electrical cooling, typically, yields technical complexity, size and power consumption, which impedes a wide-spread application of NIR spectroscopy, e.g. for point-of-care analytics, or in consumer devices.

Therefore, operation of an IR spectrometer without cooling is desired, wherein the detector materials preferably function in a wide range of operation conditions and environment temperatures. As a result, temperature-induced drifts of the detector materials need to be compensated when comparing measurements to a reference signal, or when repeating measurements in order to reduce measurement noise.

A photoresistor may exhibit a temperature dependence. For example, photoconductive detectors, e.g. made of, e.g., PbS, PbSe, show a strong temperature dependence of their dark resistance, responsivity, and detectivity. Systematic drifts can occur due to changes in electronics. For example, usually, a bias voltage is applied to photoresistors to generate a dark current and signal current and changes in temperature of electronic components can introduce systematic drifts in the measured detector signal. Both detector changes and electronic components changes may occur at the same time.

Hence, small changes in detector temperature can lead to large errors in obtained optical signals. Usually, a temperature sensor on a detector substrate is used to monitor a detector temperature. To achieve the most accurate result for multipixel devices, even several temperature sensors would be needed. Usually, thermoelectric cooler (TEC) and TEC-controllers are used to stabilize the temperature of the detector to mitigate these temperature effects. The temperature of this sensor is used to control the current through a TEC in a way to keep the temperature of this sensor as constant as possible (few mK). Hence, the temperature of the detector is estimated to be constant as well. No significant changes in responsivity due to changes in detector temperature are expected and considered.

Devices and methods are known, e.g. from JP H01110225 A, CN 2359677 Y, U.S. Pat. No. 6,852,966 B1, US20110255075 A1, CN 109307550 A, JP S61213650 A, CN 103076087 A, DE 102009026951 A1, which apply a temperature correction based on a temperature sensor, or based on a second optical detector which is identical to the primary detector.

WO 2021/069544 A1 describes a device comprising: —at least one array of photoconductors, wherein each photoconductor is configured for exhibiting an electrical resistance dependent on an illumination of its light-sensitive region, wherein at least one photoconductor of the array is designed as characterizing photoconductor; —at least one bias voltage source, wherein the bias voltage source is configured for applying at least one alternating bias voltage to the characterizing photoconductor or at least one direct current (DC) bias voltage to the characterizing photoconductor; —at least one photoconductor readout circuit, wherein the photoconductor readout circuit is configured for determining of a response voltage of the characterizing photoconductor generated in response to the bias voltage, wherein the response voltage is proportional to a variable characterizing the array of photoconductors, wherein the photoconductor readout circuit is configured for determining of the response voltage of the characterizing photoconductor during operation of the array of photoconductors.

US 2018/073923 A1 describes an optical measurement method using a detector having a detection sensitivity to at least a near-infrared region. The optical measurement method including: obtaining an output value by measuring a light sample at any exposure time with the detector; and correcting the output value with an amount of correction corresponding to the output value, when the exposure time at which the output value is obtained is within a second range. The amount of correction includes a product of a coefficient and a square of the exposure time, the coefficient indicating a degree to which an output value obtained when the light sample is measured with the detector at an exposure time within the second range deviates from output linearity obtained when the light sample is measured with the detector at an exposure time within a first range.

U.S. Pat. No. 4,773,761 A describes a photoelectric colorimeter which comprises a photoelectric conversion section including an optical filter to analyze light coming from a test piece and a reference calibrating sample into primary color elements, and a photosensor to convert each of said primary color elements into an electric signal; and a data processing section including a calibration constant calculating device for calculating a calibration constant for each of a plurality of reference calibrating samples on the basis of a calibration point of each of the reference calibrating samples and an information inputted from said photoelectric conversion section, a chromaticity point calculation device for calculating a chromaticity point of the test piece and that of each reference calibrating sample, a memory device for memorizing the calibration constant and calibration point of each of the reference calibrating samples, a device for estimating a new calibration constant suitable for the chromaticity point of the test piece between the respective calibration constants of the reference calibrating samples through the interpolation using a positional relation between the chromaticity point of the calibration point and that of the test piece as a parameter, and a correction device for correcting measured value of the test piece by the new calibration constant.

M. Krupinski et al. “Test stand for non-uniformity correction of microbolometer focal plane arrays used in thermal cameras”, SPIE SMART STRUCTURES AND MATERIALS+NONDESTRUCTIVE EVALUATION AND HEALTH MONITORING, 2005, San Diego, California, US, vol. 8896, page 889611, XP093006817, US ISSN: 0277-786X, DOI: 10.1117/12.2028633 ISBN: 978-1-5106-4548-6, refers to correction of uneven response of particular detectors (pixels) to the same incident power of infrared radiation.

US 2021/025758 A1 describes a system for non-invasively interrogating an in vivo sample for measurement of analytes which comprises a pulse sensor coupled to the in vivo sample for detect a blood pulse of the sample and for generating a corresponding pulse signal, a laser generator for generating a laser radiation having a wavelength, power and diameter, the laser radiation being directed toward the sample to elicit Raman signals, a laser controller adapted to activate the laser generator, a spectrometer situated to receive the Raman signals and to generate analyte spectral data; and a computing device coupled to the pulse sensor, laser controller and spectrometer which is adapted to correlate the spectral data with the pulse signal based on timing data received from the laser controller in order to isolate spectral components from analytes within the blood of the sample from spectral components from analytes arising from non-blood components of the sample.

Despite the advantages as implied by the above-mentioned devices and methods, there still is a need for improvements. Specifically, improved compensation for both detector changes and electronic components changes are required.

### Problem to be Solved

Therefore, the problem addressed by the present invention is that of providing methods and devices for compensating for responsivity changes of at least one photodetector which at least substantially avoid the disadvantages of known methods and devices of this type. In particular, it is desirable to provide methods and devices which ensure improved compensation for both detector changes and electronic components changes in a simple and safe fashion, specifically without the need of installing additional components.

### SUMMARY

This problem is addressed by the invention with the features of the independent claims. Advantageous embodiments which might be realized in an isolated fashion or in any arbitrary combinations are listed in the dependent claims as well as throughout the specification.

In a first aspect of the present invention, a method for determining at least one correction function for compensating for responsivity changes of at least one photodetector is disclosed. The photodetector comprises at least one photosensitive region and at least one readout electronics unit for reading out the photosensitive region. The method comprises the following steps:
a) determining at least one reference signal of the photodetector, wherein the photosensitive region is illuminated by optical radiation provided by at least one reference for determining the reference signal;
b) determining at least one background signal level of the photodetector;
c) determining the correction function by using at least one evaluation unit, wherein the determining of the correction function comprises determining a change in background signal level and evaluating a relationship of the change in background signal level and the reference signal.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion. The method may comprise repeating steps a) to c) at pre-defined times or continuously.

The method may be at least partially computer-implemented. The term “computer implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Specifically, each of the method steps is performed by the computer and/or computer network. The method may be performed completely automatically, specifically without user interaction.

The term “photodetector” as used herein is a broad term and is to be given its ordinary and customary meaning to a person of ordinary skill in the art and is not to be limited to a special or customized meaning. The term specifically may refer, without limitation, to an optical detector or sensor configured for detecting optical radiation, such as for detecting an illumination and/or a light spot generated by at least one light beam. The photodetector may comprise at least one substrate. A single photodetector may be a substrate with at least one single photosensitive area, which generates a physical response to the illumination for a given wavelength range.

The photodetector may comprise at least one photosensitive region, also denoted as photosensitive area. The photodetector may comprise a plurality of photosensitive regions, which may be arranged in at least one of an array or a matrix. The term “photosensitive region” as used herein is a broad term and is to be given its ordinary and customary meaning to a person of ordinary skill in the art and is not to be limited to a special or customized meaning. The term specifically may refer, without limitation, to a unit of a photodetector configured for being illuminated, or in other words for receiving optical radiation, and for generating at least one signal, such as an electronic signal, in response to the illumination. The photosensitive region may be located on a surface of the photodetector. The photosensitive region may specifically be a single, closed, uniform photosensitive region. However, other options may also be feasible. The photosensitive region may also be referred to as pixel.

The illumination may be provided by at least one measurement object. The providing may comprise at least one of a reflecting, transmitting and emitting. Specifically, before interacting with the measurement object, the illumination may e.g. be emitted by at least one radiation source. The term “radiation source” as used herein is a broad term and is to be given its ordinary and customary meaning to a person of ordinary skill in the art and is not to be limited to a special or customized meaning. The term specifically may refer, without limitation, to a device configured for emitting optical radiation. The radiation source may be configured for emitting optical radiation towards the measurement object, such as in form of a light beam. The radiation source may be configured for isotopically emitting optical radiation, e.g. uniformly in all spatial directions, wherein only a part of the emitted optical radiation may impinge the measurement object. The radiation source may comprise at least one of a semiconductor-based radiation source or a thermal radiator. The at least one semiconductor-based radiation source may be selected from at least one of a light emitting diode (LED) or a laser, specifically a laser diode. The LED may comprise at least one fluorescent and/or phosphorescent material. The thermal radiator may comprise at least one of an incandescent lamp, a black body emitter and a microelectromechanical system (MEMS) emitter. The radiation source may be a modulated radiation source. Further kinds of radiation sources may also be feasible.

The term “illumination” as used herein is a broad term and is to be given its ordinary and customary meaning to a person of ordinary skill in the art and is not to be limited to a special or customized meaning. The term specifically may refer, without limitation, to optical radiation, specifically within at least one of the visible, the ultraviolet or the infrared spectral range. The term “ultraviolet”, generally, refers to electromagnetic radiation having a wavelength of 1 nm to 380 nm, preferably of 100 nm to 380 nm. Further, the term “visible”, generally, refers to a wavelength of 380 nm to 760 nm. Further, the term “infrared”, “abbreviated to IR”, generally refers to a wavelength of 760 nm to 1000 μm, wherein the wavelength of 760 nm to 3 μm is, usually, denominated as “near infrared”, abbreviated to “NIR”. Preferably, the illumination which is used for typical purposes of the present invention is IR radiation, more preferred, NIR radiation, especially of a wavelength of 760 nm to 3 μm, preferably of 1 μm to 3 μm. The illumination may specifically be optical radiation impinging the photodetector, or more specifically the photosensitive region. The term “illumination” may also be referred to as “optical radiation” or as “light” herein. The photodetector may be configured for detecting optical radiation in a wavelength of 300 nm to 3000 nm, specifically 500 nm to 2500 nm, more specifically 1400 nm to 2000 nm.

The illumination may be modulated, e.g. by using a modulated radiation source. The radiation source may be a modulated radiation source. The term “modulating” including any grammatical variation thereof as used herein is a broad term and is to be given its ordinary and customary meaning to a person of ordinary skill in the art and is not to be limited to a special or customized meaning. The term specifically may refer, without limitation, to a process of changing, specifically periodically changing, at least one property of optical radiation, specifically one or both of an intensity or a phase of the optical radiation. As the skilled person will know, the intensity again relates to an amplitude of the optical radiation. The modulation may be a full modulation from a maximum value to zero, or may be a partial modulation, from a maximum value to an intermediate value greater than zero. The modulating may comprise using a modulating element. The modulating element may be configured for e.g. mechanically modulating the optical radiation, e.g. by using a rotating chopper wheel, and/or for electronically modulating the optical radiation, e.g. by using an electrooptic effect and/or an acoustoptic effect, e.g. by using a Pockels cell and/or a Kerr cell. Further options are feasible.

The photosensitive region may comprise at least one photoconductive material. The photoconductive material may be selected from at least one of PbS, PbSe, Ge, InGaAs, InSb, or HgCdTe. Other options, such as photodiodes or thermopiles, may also be feasible. The photodetector may be configured for generating at least one signal, specifically in response to an illumination of the photosensitive region, such as a photocurrent.

The photodetector comprises at least one readout electronics unit for reading out the photosensitive region. The term “readout” as used herein is a broad term and is to be given its ordinary and customary meaning to a person of ordinary skill in the art and is not to be limited to a special or customized meaning. The term specifically may refer, without limitation, to an action or process of quantifying and/or processing at least one physical property and/or a change in at least one physical property detected by at least one device, specifically by the at least one photodetector or more specifically the photosensitive region. The readout may comprise an individual readout of one device such as of one photosensitive region. Additionally or alternatively, the readout may comprise a readout of a group of devices such as a group of photosensitive regions.

The term “readout electronics unit” as used herein is a broad term and is to be given its ordinary and customary meaning to a person of ordinary skill in the art and is not to be limited to a special or customized meaning. The term specifically may refer, without limitation, to an electronics unit configured for quantifying and/or processing at least one physical property and/or a change in at least one physical property detected by the photodetector or more specifically the photosensitive region. The readout electronics unit may comprise at least one of: an operational amplifier; an analog-to-digital converter; a voltage divider; a current divider, an ASIC, specifically for subtracting a constant current for generating a signal current.

For example, the photodetector may comprise a bias voltage source. The term “bias voltage source” as used herein is a broad term and is to be given its ordinary and customary meaning to a person of ordinary skill in the art and is not to be limited to a special or customized meaning. The term specifically may refer, without limitation, to at last one voltage source configured for generating the bias voltage. The bias voltage source may be configured for applying at least one, e.g. constant, bias voltage V_{bias} to the photodetector, specifically to the photosensitive region which may be regarded as a resistance in this context. A dark signal, in particular dark current I_{D}, may be generated by applying the bias voltage V_{bias} to the photosensitive region by using the bias voltage source. A dark current I_{D} may flow through the photodetector with I_{D}=V_{bias}/R_{D}, with V_{bias} being the bias voltage and R_{D} being the dark resistance. The readout electronics unit may be configured for subtracting a constant current I_{q} from the dark current I_{D} which results in the signal current I_{S}=I_{D}−I_{q}. The signal current I_{S} may be amplified by front-end electronics (AMP) and a digital signal S may be generated afterwards using an analog-to-digital converter (ADC). Changes in V_{bias} can result in changes in responsivity changes which can be corrected by using the compensation method according to the present invention.

The term “compensation” including any grammatical variation thereof as used herein is a broad term and is to be given its ordinary and customary meaning to a person of ordinary skill in the art and is not to be limited to a special or customized meaning. The term specifically may refer, without limitation, to a cancellation or a correction of a physical effect, specifically of a disturbing influence or interference or perturbation. The compensation may be or may comprise a measure against the perturbation. Specifically, the compensation may be a temperature compensation, wherein the temperature, or more specifically temperature variations, may be a perturbation, e.g. for a detector. As an example, a responsivity of a photodetector may be temperature dependent. Thus, variations of an environmental temperature of the photosensitive region may lead to additional variations of the detector signal which are not responsive to an illumination of the photodetector. In other words, the detector signal may be subject to a temperature drift.

The method may comprise compensating a change of the responsivity of the photosensitive region caused by a physical quantity affecting a resistance, specifically a dark resistance, of the photosensitive region. The method may comprise compensating a change of the responsivity of the photosensitive region caused by at least one of: a change of a temperature of the photosensitive region; a change of an illumination of the photosensitive region, specifically by at least one background radiation; a change of a temperature of the evaluation unit or at least parts thereof; a change of at least one physical quantity, specifically of a temperature, of the photodetector or at least of parts thereof, specifically of at least one optional further electronic component of the photodetector as described above or as described in more detail below.

The term “responsivity” as used herein is a broad term and is to be given its ordinary and customary meaning to a person of ordinary skill in the art and is not to be limited to a special or customized meaning. The term specifically may refer, without limitation, to a relation between at least one input and at least one output of the photodetector. The responsivity may be a relation between an optical input and an electrical output. The responsivity may measure the electrical output, e.g. a photocurrent or a resistance, per optical input, e.g. an illumination intensity or irradiance. The responsivity may also be referred to as photosensitivity. The term “responsivity change” as used herein is a broad term and is to be given its ordinary and customary meaning to a person of ordinary skill in the art and is not to be limited to a special or customized meaning. The term specifically may refer, without limitation, to any deviation in responsivity, e.g. relative to a pre-defined value and/or responsivity determined at a different point in time.

In step a) at least one reference signal of the photodetector is determined. The photosensitive region is illuminated by optical radiation provided by at least one reference for determining the reference signal. In step b) at least one background signal level of the photodetector is determined.

The term “signal” as used herein is a broad term and is to be given its ordinary and customary meaning to a person of ordinary skill in the art and is not to be limited to a special or customized meaning. The term specifically may refer, without limitation, to an observable change in at least one physical quantity. The signal may be or comprise a sign or a function conveying information about the at least one physical quantity. The signal may specifically be or comprise at least one of an electronic signal, an optical signal or an optoelectronic signal. The signal may be a variable signal, specifically over time. The signal may be or comprise at least one of a variable voltage, a variable current, a variable charge, a variable resistance or, generally, a variable electromagnetic wave. The variable electromagnetic wave may comprise at least one of a variable amplitude, a variable frequency or a variable phase. Further options are feasible and generally known to the skilled person.

The term “reference” as used herein is a broad term and is to be given its ordinary and customary meaning to a person of ordinary skill in the art and is not to be limited to a special or customized meaning. The term specifically may refer, without limitation, to at least one arbitrary object. Specifically, the reference may have at least one known physical property, in particular at least one optical property. Other embodiments are feasible. For example, the reference may have unknown physical properties. For example, the reference may be a measurement object such as a sample to be measured. As an example, when analyzing a measurement object, a plurality of measurement values may be recorded, wherein at least one measurement value may be used as a reference value.

The term “measurement object” as used herein is a broad term and is to be given its ordinary and customary meaning to a person of ordinary skill in the art and is not to be limited to a special or customized meaning. The term specifically may refer, without limitation, to an arbitrary body, chosen from a living body and a non-living body. The measurement object may specifically comprise at least one material which is subject to an investigation. The measurement object may generally refer to an object which is to be measured, e.g. for which a spectrum is to be recorded, wherein the measurement object may have in principle arbitrary properties, e.g. arbitrary optical properties or an arbitrary shape. The measurement object may comprise at least one solid sample. However, other measurement objects such as fluids may also be feasible.

The term “reference signal” as used herein is a broad term and is to be given its ordinary and customary meaning to a person of ordinary skill in the art and is not to be limited to a special or customized meaning. The term specifically may refer, without limitation, to a signal generated by the photodetector in response to illumination by optical radiation provided by the reference. Specifically, the reference signal may be generated by the photosensitive region in response to illumination. The reference signal may be or comprise at least one signal generated at a single point in time. The reference signal may be or comprise at least one signal generated over a time period. The reference signal may be or comprise at least one preprocessed signal, such as a filtered or smoothened or amplified signal. The reference signal may be or comprise at least one of an analog signal or a digital signal.

Step a) may comprise determining a plurality of reference signals. For example, reference signals may be determined for different conditions of the photodetector, in particular for one or more of different temperatures of the photosensitive region; different illumination of the photosensitive region; different temperatures of an evaluation unit or at least parts thereof; different physical quantities of the photodetector or at least of parts thereof, specifically of at least one optional further electronic component of the photodetector described below, different bias voltage. The reference signals may be determined at different times. For example, reference signals may be determined for different pre-defined temperatures.

The reference signal may be measured online during sample measurement using frequency multiplexing and/or by measuring the reference signal throughout at least one extended time period without sample measurement. For example, for sample measurement and measurement of the reference signal different frequencies may be used. For example, the optical radiation in step a) may be modulated. Additionally or alternatively, the reference signal may be measured before or after sample measurement.

The term “background signal” as used herein is a broad term and is to be given its ordinary and customary meaning to a person of ordinary skill in the art and is not to be limited to a special or customized meaning. The term specifically may refer, without limitation, to a signal generated by the photodetector independent of an illumination. For example, for determining the background signal, the photosensitive region may be covered by at least one opaque cover and/or unilluminated. As an example, the photosensitive region may be unilluminated, at least for predefined time intervals, when using modulated optical radiation. The modulation may be a full modulation down to zero intensity, such that the photosensitive region may be unilluminated in a minimum of the intensity of the modulated optical radiation. For example, without being illuminated, the photosensitive region may be configured for generating the background signal. The background signal may be a signal generated by the photosensitive region, wherein an illumination of the photosensitive region is inhibited when generating the background signal. The background signal may be dependent on at least one intrinsic property of the photosensitive region, specifically a material property of at least one semiconductor comprised by the photosensitive region. The background signal may specifically be dependent on a temperature of the photosensitive region. The background signal may comprise a dark signal, in particular a dark current. The dark current may be thermally induced by a spontaneous formation of free charge carriers within a semiconductor of the photosensitive region.

The term “background signal level” as used herein is a broad term and is to be given its ordinary and customary meaning to a person of ordinary skill in the art and is not to be limited to a special or customized meaning. The term specifically may refer, without limitation, to a mean of minima of the background signal. In step a), the optical radiation may be modulated. The background signal level may be determined by using times and phase of minima of the modulated optical radiation. The determining of the background signal level may comprise extrapolating dark signals and/or modeling the dark signals. For example, dark signals may be extracted only from the dark phases. The extrapolating may comprise extrapolating to times in which the background signal is not determined, e.g. during illumination of the photosensitive region e.g. during determining of the reference signal and/or during sample measurement. The modeling of the measured dark signals may comprise fitting the measured dark signals, e.g. using a pre-defined fitting function on the identified minima. For example, the pre-defined fitting function may be a linear function.

The method may comprise measuring, in particular both of, the reference signal and the background signal under at least two different conditions of the photodetector. The conditions of the photodetector may be set by setting and/or adjusting a value of at least one influencing variable. The influencing variable may be at least one variable affecting a dark resistance of the photosensitive region. The influencing variable may be at least one variable selected from the group consisting of: a temperature of the photosensitive region; an illumination of the photosensitive region; a temperature of the evaluation unit or at least parts thereof; at least one physical quantity of the photodetector or at least of parts thereof, specifically of at least one optional further electronic component of the photodetector described below, a bias voltage.

The background signal level and the reference signal may be measured timely coincident. The term “timely coincident” as used herein is a broad term and is to be given its ordinary and customary meaning to a person of ordinary skill in the art and is not to be limited to a special or customized meaning. The term specifically may refer, without limitation, to the fact that determining of the reference signal and dark signals is performed in one and the same measurement and/or at the same time. Measuring timely coincident may be possible by using not only time information of a timely coincident measured signal but, in addition, phase information. The timely coincident measured signal S can be describe as a composite polynomial S(phase, t)=P1(phase)+P2(t), where P1 and P2 are polynomials as a function of the phase and time, respectively. P1 may be chosen such that it reaches 0 at the phase of minimum signal; then, P2 describes the dark signal with time such that the dark signal can be modelled. The method may comprise considering the complete coincident measured signal or only parts of the coincident measured signal. For example, parts of the coincident measured signal about a predefined limit, e.g. about ±1 ms, away from a minimum phase may be used of the dark signal modelling. The optimization of the problem and analytical description for dark signal modelling may depend on one or more of a modulation form, frequency, and signal decay time, as well as the used light source. Measuring timely coincident may allow online calibration, i.e. during operation of the photodetector. Measuring timely coincident may allow preventing the need of additional calibration times, and therefore enhancing measurement efficiency.

For example, the determining of the background signal level in step b) may comprise determining dark signals from dark phases during determining of the reference signal. The term “dark phase” as used herein is a broad term and is to be given its ordinary and customary meaning to a person of ordinary skill in the art and is not to be limited to a special or customized meaning. The term specifically may refer, without limitation, to at least one time range in which the photosensitive region is covered by at least one opaque cover and/or is unilluminated. For example, dark signals may be extracted from the dark phases and may be extrapolated for the phases where illumination is incident on the photosensitive region. However, other embodiments are feasible. For example, the background signal level and the reference signal may be measured at different times. For example, step b) may comprise determining dark signals before and/or between and/or after determining of the reference signal.

The method may use the dark current together with a, not necessarily timely coincident, reference signal to correct for responsivity changes. As outlined above, determining of dark signals can be performed during dark phases such that no additional measurements before and/or after a sample measurement are necessary. This may allow that even small scale variations, i.e. time scales lower than a measurement time, are trackable. In addition, the method may comprise determining dark signals before and/or between and/or after modulated measurements such that dark signals are determined in the truly dark for the entire measurement period. The determining of coefficients of the correction functions can be performed by actively tracking the reference signal and dark signals in an online fashion. This can be achieved either through frequency multiplexing or by tracking the reference throughout extended time periods, where no sample measurement is obtained.

Step c) comprises determining the correction function by using at least one evaluation unit. The determining of the correction function comprises determining a change in background signal level and evaluating a relationship of the change in background signal level and the reference signal.

The term “evaluation” including any grammatical variation thereof as used herein is a broad term and is to be given its ordinary and customary meaning to a person of ordinary skill in the art and is not to be limited to a special or customized meaning. The term specifically may refer, without limitation, to analyzing or interpreting data, specifically for determining at least one item of qualitative or quantitative information. The evaluation may comprise processing the data, such as by using at least one relation, specifically at least one function having at least one of a variable or a predetermined parameter.

The term “evaluation unit” as used herein is a broad term and is to be given its ordinary and customary meaning to a person of ordinary skill in the art and is not to be limited to a special or customized meaning. The term specifically may refer, without limitation, to a device configured for analyzing or interpreting data, specifically for determining at least one item of qualitative or quantitative information. The information may specifically be obtained by evaluating at least one detector signal generated by the at least one photodetector. The evaluation unit may be or may comprise at least one of an integrated circuit, in particular an application-specific integrated circuit (ASIC), or a data processing device, in particular at least one of a digital signal processor (DSP), a field programmable gate array (FPGA), a microcontroller, a microcomputer, a computer, or an electronic communication unit, specifically a smartphone or a tablet. Further components may be feasible, in particular at least one preprocessing device or data acquisition device. Further, the evaluation unit may comprise at least one interface, in particular at least one of a wireless interface or a wire-bound interface. Further, the evaluation unit can be designed to, completely or partially, control or drive further devices, such as the at least one photodetector. The information as determined by the evaluation unit may, in particular, be provided to at least one of a further apparatus, or to a user, preferably in at least one of an electronic, visual, acoustic, or tactile fashion. Further, the information may be stored in at least one data storage unit, specifically in an internal data storage unit as comprised by the photodetector or at least the spectrometer, in particular by the at least one evaluation unit, or in an separate storage unit to which the information may be transmitted via the at least one interface. The separate storage unit may be comprised by the at least one electronic communication unit. The storage unit may in particular be configured for storing at least one electronic table, such as at least one look-up table.

The evaluation unit may, preferably, be configured to perform at least one computer program, in particular at least one computer program performing or supporting the steps of the methods according to the present invention. For this purpose, the evaluation unit may, particularly, comprise at least one data processing device, in particular at least one of an electronic or an optical data processing device. The processing device may be designed for determining of the correction function.

The at least one photodetector may comprise the evaluation unit and/or a communication interface. The communication interface may be configured for transmitting data at least one of from or to or within the evaluation unit. The term “communication interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the communication interface may be configured for transferring information from a computational device, e.g. a computer, such as to send or output information, e.g. onto another device. Additionally or alternatively, the communication interface may be configured for transferring information onto a computational device, e.g. onto a computer, such as to receive information. The communication interface may specifically provide means for transferring or exchanging information. In particular, the communication interface may provide a data transfer connection, e.g. Bluetooth, NFC, inductive coupling or the like. As an example, the communication interface may be or may comprise at least one port comprising one or more of a network or internet port, a USB-port and a disk drive. The communication interface may comprise at least one web interface.

The at least one evaluation unit may be at least partially cloud-based. The term “cloud-based” as used herein is a broad term and is to be given its ordinary and customary meaning to a person of ordinary skill in the art and is not to be limited to a special or customized meaning. The term specifically may refer, without limitation, to an outsourcing of the at least one evaluation unit or of parts of the at least one evaluation unit to at least partially interconnected external devices, specifically computers or computer networks having larger computing power and/or data storage volume. The external devices may be arbitrarily spatially distributed. The external devices may vary over time, specifically on demand. The external devices may be interconnected by using the internet. The external devices may each comprise at least one communication interface.

The term “correction function” as used herein is a broad term and is to be given its ordinary and customary meaning to a person of ordinary skill in the art and is not to be limited to a special or customized meaning. The term specifically may refer, without limitation, to a mathematical function for compensating for responsivity changes of the photodetector. The correction function may comprise at least one coefficient. The correction function may be a function selected from the group consisting of: a linear function; a polynomial function; an exponential function. The correction function may be applied for correcting any measured signal (including sample measurements) at its corresponding dark signal level.

The determining of the correction function comprises determining a change in background signal level. The method may comprise retrieving at least one initial background signal level. The retrieving of the initial background signal level may comprise measuring and/or using a pre-defined, e.g. stored value such as a value retrieved from a lookup table. For example, the initial background level may be a first background level at a first system state such as at a first temperature. The determining of the change in background signal level comprises comparing the initial background signal level and the background signal level determined in step b). The initial background signal level may be a background signal level which was determined previous background signal level, e.g. which was determined during a previous measurement and/or which was determined during previous execution of the method according to the present invention.

The determining of the correction function comprises evaluating a relationship of the change in background signal level and the reference signal. The change of the background signal level may be determined relative to the reference signal that corresponds to a zero-point of the dark signal change. The correction function may be determined by fitting the correction function to the relationship of the change of background signal level and the reference signal, thereby determining the parameters of the correction function. The correction function may be fit to the relationship of reference signal vs. modeled changes in the dark signal. For example, the correction function is a linear function

$${S}_{i} = \frac{( {S}_{ref , 2} - {S}_{ref , 1} )}{( {D}_{2} - {D}_{1} )} ( {D}_{i} - {D}_{1} ) + {S}_{ref , 1} ,$$

wherein S_{ref, 1} is a first reference signal having background level D₁, S_{ref, 2} is a second reference signal having background level D₂.

S_{ref, 1} with D₁ and S_{ref,2} with D₂ may be determined at two different system states such as at different times and/or at different temperatures and the like. These values may be used for determining of a calibration coefficient (in case of a linear correction function) and the correction function is completely defined. Thus, advantageously, it may not be necessary to have knowledge about a reference or absolute temperature.

For example, the method may be used for compensating for systematic changes in dark resistance. Any change in dark resistance can result in a change in the dark current and therefore a change in signal current will be seen. A change in dark resistance may be caused by a change in the detector temperature but also by background light or any other quantity that may affect the resistance of the photodetector itself. In fact, the method according to the present invention may allow for a universal correction scheme for all means of resistance changes. Further, any signals or currents originated by an optical signal on the photodetector can be obtained since those also impact the detector's resistance. The optical signal may be modulated in order to enable efficient signal processing that distinguishes the signal from the dark signal and the noise, and systematic drifts. Longterm stability may change with time but using defined reference signal level, an online calibration may be feasible by using the method according to the present invention. The background signal level and reference signal may be determined in modulated manner and/or during a sample measurement by monitoring the dark phases, e.g. either before/after a sample measurement. A change in responsivity (photosensitivity) can be determined from the change in the dark signal/current as monitored by the (change in) reference signal. In order to obtain more precise calibrations, repeated calibration measurements may be acquired.

For example, the method according to the present invention may be used for compensating for systematic drifts in the current I_{q} and/or the bias voltage V_{bias}, in particular in case of using a stabilized detector. The photodetector further may comprise at least one temperature stabilizing device, specifically a thermoelectric cooler, for controlling a temperature of the photodetector or at least of parts thereof, specifically of the photosensitive region. Such a photodetector may be denoted “stabilized detector” herein. The dark resistance may be kept stable by means of, e.g., a TEC. The systematic drifts may be, for example, caused by environmental condition variations such as changes in the temperature of electronic components other than the photodetector itself. Under the condition that the dark resistance is constant, any change in I_{q} or I_{D} (i.e., originated from a change in V_{bias}) may result in a change in Is and therefore in the digital signal S. For photoresistors, the responsivity may be given by fundamental detector characteristics and the applied bias voltage V_{bias}. Hence, changes in V_{bias} may result in changes of the responsivity. Therefore, the method according to the present invention may be also applied to compensate such systematic drifts in electronics as the changes are mapped in the dark signal.

The term “temperature stabilizing device” as used herein is a broad term and is to be given its ordinary and customary meaning to a person of ordinary skill in the art and is not to be limited to a special or customized meaning. The term specifically may refer, without limitation, to an element or device configured for keeping a temperature of a further element or device constant or steady or stable. Specifically, the at least one temperature stabilizing device may be configured for stabilizing the temperature of the photodetector. The temperature stabilizing device may be configured for keeping the temperature of components of the photodetector such as the photosensitive region and/or the readout electronics unit at a predetermined level. The temperature stabilizing device may be configured for stabilizing the temperature of components of the photodetector such as the photosensitive region and/or the readout electronics unit. The temperature stabilizing device may be or comprise at last one thermoelectric cooler. The term “thermoelectric cooler” as used herein is a broad term and is to be given its ordinary and customary meaning to a person of ordinary skill in the art and is not to be limited to a special or customized meaning. The term specifically may refer, without limitation, to an electrically driven heat pump configured for transferring heat between at least two spatial areas, thereby generating a heat flux between the at least two spatial areas. The thermoelectric cooler may, specifically, be based on the Peltier effect in order to create the heat flux. For this purpose, the thermoelectric cooler may, especially, comprise at least one Peltier element. A direction of the heat flux may depend on a direction of an electrical current applied to the thermoelectric cooler. Depending on the direction of the heat flux, the thermoelectric cooler can be used for cooling at least one spatial area by transferring heat to at least one further spatial area, or for heating the spatial area by transferring heat from the at least one further spatial area. Other options may also be feasible.

The present invention relates to a compensation method, in particular for determining at least one correction function for compensating for responsivity changes of at least one photodetector. In particular, the present invention proposes a self-referencing of the photodetector such as of one photosensitive region, e.g. of one pixel. The method comprises using the same photosensitive region, e.g. the same pixel, for determining the reference signal and the background signal. Thus, the signal of said photosensitive region and its background signal are used resulting in a self-referencing. This self-referencing can allow for applying a constant bias voltage to the photosensitive region.

In contrast, WO 2021/069544 A1 proposes to use several photodetectors, i.e. several photosensitive regions, for referencing and application of an alternating bias voltage.

In a further aspect of the present invention, a method for determining at least one item of information on at least one measurement object using at least one photodetector is disclosed. The photodetector comprises at least one photosensitive region and at least one readout electronics unit for reading out the photosensitive region. The method comprises the following steps:
i) providing optical radiation by the measurement object and determining at least one measurement signal by using the photodetector;
ii) correcting the measurement signal by using a correction function by using at least one evaluation unit, wherein the correction function is determined by using the method for determining at least one correction function according to the present invention; and
iii) determining the item of information on the measurement object by evaluating the corrected measurement signal by using the evaluation unit.

The method steps may be performed in the indicated order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

The term “item of measurement information” as used herein is a broad term and is to be given its ordinary and customary meaning to a person of ordinary skill in the art and is not to be limited to a special or customized meaning. The term specifically may refer, without limitation, to knowledge or evidence providing a qualitative and/or quantitative description relating to at least one measurement, specifically to the at least one measurement object. The item of measurement information may comprise at least one of a physical property of the measurement object or a chemical composition of the at least one measurement object. The physical property may specifically comprise an optical property such at least one absorbance of the measurement object and/or at least one emissivity of the measurement object. The chemical composition may specifically refer to qualitative and/or quantitative information on at least one material the measurement object comprises.

In step i), the optical radiation provided by the at least one measurement object may comprise a wavelength of 300 nm to 3000 nm, specifically 500 nm to 2500 nm, more specifically 1400 nm to 2000 nm. The term “providing” including any grammatical variation thereof as used herein is a broad term and is to be given its ordinary and customary meaning to a person of ordinary skill in the art and is not to be limited to a special or customized meaning. The term specifically may refer, without limitation, to at least one of reflecting, specifically diffusely; diffracting; transmitting and emitting optical radiation. The optical radiation provided by the measurement object may be indicative of at least one of a physical property of the measurement object, e.g. an optical property and/or a temperature of the measurement object, and a chemical property of the measurement object, e.g. a chemical composition of the measurement object. As an example, the optical radiation provided by the measurement object may be emitted by the at least one measurement object, specifically at least partially towards the photodetector. Further, the optical radiation provided by the at least one measurement object may be reflected by the at least one measurement object at least partially towards the at least one photodetector, e.g. diffusely. Further, the optical radiation provided by the at least one measurement object may be transmitted through the at least one measurement object at least partially towards the at least one photodetector. However, the at least one measurement object may also at least partially absorb the optical radiation, which may specifically be indicative of at least one physical property of the at least one measurement object and/or at least one chemical property of the at least one measurement object such as a chemical composition of at least one material forming the at least one measurement object.

Step ii) comprises correcting the measurement signal by using a correction function by using the evaluation unit. The correction function is determined by using the method for determining at least one correction function according to the present invention. For further details regarding to the method for determining at least one item of measurement information, reference may be made to the description of the method for determining at least one correction function as described above or in more detail below.

Step iii) comprises determining the item of information on the measurement object by evaluating the corrected measurement signal by using the evaluation unit. For example, the correction function is a linear function, wherein an i^{th} measurement signal S_{meas,i} is corrected into a corrected signal S_{corr,i} by

$${S}_{corr , i} = \frac{{S}_{meas , i}}{c \cdot ( ( {D}_{meas , i} - {D}_{1} ) + 1 )} ,$$

$$with$$

$$c = \frac{\frac{{S}_{ref , 2}}{{S}_{ref , 1}} - 1}{{D}_{2} - {D}_{1}} ,$$

D₁ being an initial background signal level, D₂ being the background signal level used for determining the correction function, D_{meas,i} being the background signal level of the measurement signal S_{meas,i}, S_{ref, 1} is a first reference signal having background level D₁, S_{ref, 2} is a second reference signal having background level D₂.

The method for determining at least one item of measurement information may at least partially be computer-implemented. Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Further disclosed and proposed herein is a computer program including computer-executable instructions for performing the one or more of the methods according to the present invention in one or more of the embodiments enclosed herein when the program is executed on a computer or computer network. Specifically, the computer program may be stored on a computer-readable data carrier and/or on a computer-readable storage medium. Thus, further disclosed and proposed herein is a non-transient computer-readable medium including instructions that, when executed by one or more processors, cause the one or more processors to perform at least one of the methods according to the present invention. Specifically, one, more than one or even all of method steps a) to c) and i) to iii) as indicated above may be performed and/or may be executed by using one or more processors.

For example, the non-transient computer-readable medium includes instructions that, when executed by the one or more processors, cause executing the method for determining at least one correction function for compensating for responsivity changes of at least one photodetector. In particular, the one or more processors may provide instructions to the photodetector and/or at least one control unit of the photodetector for executing and/or performing determining at least one reference signal and at least one background signal. Moreover, the one or more processors, in particular as evaluation unit, may perform step c), i.e. determining the correction function comprising determining a change in background signal level and evaluating a relationship of the change in background signal level and the reference signal.

For example, the non-transient computer-readable medium includes instructions that, when executed by the one or more processors, cause executing the method for determining at least one item of information on at least one measurement object. In particular, the one or more processors may provide instructions to a photodetector for executing and/or performing a measurement. Moreover, the one or more processors, in particular as evaluation unit, may perform steps ii) and iii), i.e. correcting the measurement signal by using a correction function by using at least one evaluation unit, wherein the correction function is determined by using the method according to any one of the preceding claims referring to a method for determining at least one correction function, and determining the item of information on the measurement object by evaluating the corrected measurement signal by using the evaluation unit.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to c) and i) to iii) as indicated above may be performed by using a computer or a computer network, preferably by using a computer program.

Further disclosed and proposed herein is a computer program product having program code means, in order to perform the methods according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the methods according to one or more of the embodiments disclosed herein.

Further disclosed and proposed herein is a computer program product with program code means stored on a machine-readable carrier, in order to perform the methods according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the methods according to one or more of the embodiments disclosed herein.

Referring to the computer-implemented aspects of the invention, one or more of the method steps or even all of the method steps of the methods according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the methods according to one of the embodiments described in this description,
a computer loadable data structure that is adapted to perform the methods according to one of the embodiments described in this description while the data structure is being executed on a computer,
a computer program, wherein the computer program is adapted to perform the methods according to one of the embodiments described in this description while the program is being executed on a computer,
a computer program comprising program means for performing the methods according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the methods according to one of the embodiments described in this description after having been loaded into a main and/or working storage of a computer or of a computer network, and
a computer program product having program code means, wherein the program code means can be stored or are stored on a storage medium, for performing the methods according to one of the embodiments described in this description, if the program code means are executed on a computer or on a computer network.

In a further aspect of the present invention, a photodetector for measuring optical radiation is disclosed. The photodetector is configured for performing the method for determining at least one correction function for compensating for responsivity changes of at least one photodetector according to the present invention and/or for performing the method for determining at least one item of information on a measurement object according to the present invention. The photodetector comprises at least one photosensitive region and at least one readout electronics unit.

The readout electronics unit may comprise one or more of at least one bias voltage source, at least one operational amplifier; at least one analog-to-digital converter; at least one voltage divider; at least one current divider; an ASIC.

The at least one photosensitive region may comprise at least one photoconductive material. The photoconductive material may be selected from at least one of PbS, PbSe, Ge, InGaAs, InSb, or HgCdTe. The photosensitive region may be configured as a photoconductor or photodiode. The photosensitive region may be optically active. The photosensitive region may generate an electrical signal when illuminated. An integrated circuit may condition, amplify and/or digitize an optically induced electrical signal. The at least one photodetector may comprise at least one of an evaluation unit or a communication interface configured for transmitting data at least one of from or to or within the evaluation unit. The at least one evaluation unit may be at least partially cloud-based. The at least one readout electronics unit may be wired to at least one of the at least one evaluation unit or the at least one communication interface.

The photodetector further may comprise at least one temperature stabilizing device, specifically a thermoelectric cooler.

For further details regarding to the photodetector, reference may be made to the description of the methods as given above or as described in more detail below. In particular, as outlined above, the at least one photodetector may comprise the evaluation unit and/or a communication interface configured for transferring information onto a computational device. As further outlined above, the evaluation unit may further be designed to, completely or partially, control or drive the photodetector.

In a further aspect of the present invention, a spectrometer for spectrally analyzing optical radiation provided by at least one measurement object is disclosed. The spectrometer comprises:
at least one radiation source configured for emitting optical radiation at least partially towards the at least one measurement object; and
at least one photodetector according to any one of the embodiments described above or below in further detail referring to a photodetector.

The term “spectrum” including a grammatical variation thereof as used herein is a broad term and is to be given its ordinary and customary meaning to a person of ordinary skill in the art and is not to be limited to a special or customized meaning. The term specifically may refer, without limitation, to a partition of the optical radiation, wherein the spectrum is constituted by an optical signal defined by a signal wavelength and a corresponding signal intensity. In particular, the spectrum may comprise spectral information related to at least one measurement object, such as a type and composition of at least one material forming the at least one measurement object, which can be determined by recording at least one spectrum related to the at least one measurement object. The term “spectrometer” as used herein is a broad term and is to be given its ordinary and customary meaning to a person of ordinary skill in the art and is not to be limited to a special or customized meaning. The term specifically may refer, without limitation, to an apparatus which is configured for determining spectral information by recording at least one measured value for at least one signal intensity related to at least one corresponding signal wavelength of optical radiation and by evaluating at least one detector signal which relates to the signal intensity.

The spectrometer further may comprise at least one evaluation unit. The evaluation unit may further be designed to, completely or partially, control or drive the spectrometer or a part thereof, such as the radiation source. The photodetector may comprise the evaluation unit. However, the evaluation unit may also be at least partially arranged outside the photodetector, such as in the spectrometer. Thus, the spectrometer may comprise the evaluation unit. Additionally or alternatively, the evaluation unit may at least partially be arranged outside of the spectrometer, such as in an external device, e.g. a computer, a smartphone or a tablet. The evaluation unit may at least partially be cloud-based. The spectrometer may comprise at least one communication interface for configured for transmitting data at least one of from or to or within the evaluation unit.

The spectrometer may further comprise at least one optical filter element configured for filtering the optical radiation or more specifically selected wavelengths of the optical radiation. The at least one optical filter element may specifically be positioned in a beam path before the photosensitive region. The spectrometer may comprise a plurality of photodetectors, each comprising one or more photosensitive regions, and a plurality of optical filter elements. The optical filter element may be positioned in a beam path before at least one photodetector, wherein the plurality of optical filter elements may be configured for at least partially filtering different wavelengths.

For further details regarding to the spectrometer, reference may be made to the description of the photodetector and the methods above and as described in more detail below.

In a further aspect of the present invention, a use of a spectrometer according to any one of the embodiments described above or below in further detail referring to a spectrometer is disclosed for a purpose of use, selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:
Embodiment 1: A method for determining at least one correction function for compensating for responsivity changes of at least one photodetector, wherein the photodetector comprises at least one photosensitive region and at least one readout electronics unit for reading out the photosensitive region, the method comprising the following steps:
   a) determining at least one reference signal of the photodetector, wherein the photosensitive region is illuminated by optical radiation provided by at least one reference for determining the reference signal;
   b) determining at least one background signal level of the photodetector;
   c) determining the correction function by using at least one evaluation unit, wherein the determining of the correction function comprises determining a change in background signal level and evaluating a relationship of the change in background signal level and the reference signal.
Embodiment 2: The method according to the preceding embodiment, wherein the background signal level and the reference signal are measured timely coincident.
Embodiment 3: The method according to any one of the preceding embodiments, wherein the reference signal is measured online during sample measurement using frequency multiplexing and/or by measuring the reference signal throughout at least one extended time period without sample measurement.
Embodiment 4: The method according to any one of the preceding embodiments, wherein the determining of the background signal level in step b) comprises determining dark signals from dark phases during determining of the reference signal.
Embodiment 5: The method according to any one of the preceding embodiments, wherein the background signal level and the reference signal are measured at different times.
Embodiment 6: The method according to any one of the preceding embodiments, wherein step b) comprises determining dark signals before and/or between and/or after determining of the reference signal.
Embodiment 7: The method according to the preceding embodiment, wherein the photosensitive region is covered by at least one opaque cover and/or unilluminated.
Embodiment 8: The method according to any one of the two preceding embodiments, wherein determining the background signal level comprises extrapolating dark signals and/or modeling the dark signals.
Embodiment 9: The method according to any one of the preceding embodiments, wherein, in step a), the optical radiation is modulated.
Embodiment 10: The method according to the preceding embodiment, wherein the background signal level is determined by using times and phase of minima of the modulated optical radiation.
Embodiment 11: The method according to any one of the preceding embodiments, wherein the method comprises retrieving at least one initial background signal level, wherein the determining of the change in background signal level comprises comparing the initial background signal level and the background signal level determined in step b).
Embodiment 12: The method according to any one of the preceding embodiments, wherein the method comprises measuring the reference signal and the background signal under at least two different conditions of the photodetector, wherein the conditions of the photodetector are set by setting and/or adjusting a value of at least one influencing variable.
Embodiment 13: The method according to the preceding embodiment, wherein the influencing variable is at least one variable affecting a dark resistance of the photosensitive region, wherein the influencing variable is at least one variable selected from the group consisting of: a temperature of the photosensitive region; an illumination of the photosensitive region; a temperature of the evaluation unit or at least parts thereof; at least one physical quantity of the photodetector or at least of parts thereof, a bias voltage.
Embodiment 14: The method according to any one of the preceding embodiments, wherein the change of the background signal level is determined relative to the reference signal that corresponds to a zero-point of the dark signal change.
Embodiment 15: The method according to any one of the preceding embodiments, wherein the correction function is fit to the relationship of the change of background signal level and the reference signal.
Embodiment 16: The method according to any one of the preceding embodiments, wherein the correction function comprises at least one coefficient, wherein the correction function is a function selected from the group consisting of: a linear function; a polynomial function; an exponential function.
Embodiment 17: The method according to any one of the preceding embodiments, wherein the correction function is a linear function

$${S}_{i} = \frac{( {S}_{ref , 2} - {S}_{ref , 1} )}{( {D}_{2} - {D}_{1} )} ( {D}_{i} - {D}_{1} ) + {S}_{ref , 1} ,$$

wherein S_{ref, 1} is a first reference signal having background level D₁, S_{ref, 2} is a second reference signal having background level D₂.
Embodiment 18: The method according to any one of the preceding embodiments, wherein the method comprises repeating steps a) to c) at pre-defined times or continuously.
Embodiment 19: The method according to any one of the preceding embodiments, wherein the method comprises compensating a change of the responsivity of the photosensitive region caused by a physical quantity affecting a resistance of the photosensitive region.
Embodiment 20: The method according to any one of the preceding embodiments, wherein the method comprises compensating a change of the responsivity of the photosensitive region caused by at least one of: a change of a temperature of the photosensitive region; a change of an illumination of the photosensitive region; a change of a temperature of the evaluation unit or at least parts thereof; a change of at least one physical quantity, of the photodetector or at least of parts thereof.
Embodiment 21: The method according to any one of the preceding embodiments, wherein the readout electronics unit comprises at least one bias voltage source, wherein a dark signal is generated by applying at least one bias voltage V_{bias} to the photosensitive region by using the bias voltage source.
Embodiment 22: The method according to any one of the preceding embodiments, wherein the readout electronics unit may comprise at least one of: an operational amplifier; an analog-to-digital converter; a voltage divider; a current divider, an ASIC.
Embodiment 23: The method according to any one of the preceding embodiments, wherein the photodetector further comprises at least one temperature stabilizing device for controlling a temperature of the photodetector or at least of parts thereof.
Embodiment 24: The method according to any one of the preceding embodiments, wherein the photosensitive region comprises at least one photoconductive material.
Embodiment 25: The method according to any one of the preceding embodiments, wherein the photoconductive material is selected from at least one of PbS, PbSe, Ge, InGaAs, InSb, and HgCdTe.
Embodiment 26: The method according to any one of the preceding embodiments, wherein photodetector comprises the evaluation unit and/or at least one communication interface for transmitting data from and/or to and/or within the evaluation unit.
Embodiment 27: The method according to any one of the preceding embodiments, wherein the evaluation unit is at least partially cloud based.
Embodiment 28: The method according to any one of the preceding method embodiments, wherein the method is at least partially computer-implemented.
Embodiment 29: A method for determining at least one item of information on at least one measurement object using at least one photodetector, wherein the photodetector comprises at least one photosensitive region and at least one readout electronics unit for reading out the photosensitive region, the method comprising the following steps:
   i) providing optical radiation by the measurement object and determining at least one measurement signal by using the photodetector;
   ii) correcting the measurement signal by using a correction function by using at least one evaluation unit, wherein the correction function is determined by using the method according to any one of the preceding embodiments referring to a method for determining at least one correction function; and
   iii) determining the item of information on the measurement object by evaluating the corrected measurement signal by using the evaluation unit.
Embodiment 30: The method according to the preceding embodiment, wherein the correction function is a linear function, wherein an i^{th} measurement signal S_{meas,i} is corrected into a corrected signal S_{corr,i} by

$${S}_{corr , i} = \frac{{S}_{meas , i}}{c \cdot ( ( {D}_{meas , i} - {D}_{1} ) + 1 )} ,$$

$$with$$

$$c = \frac{\frac{{S}_{ref , 2}}{{S}_{ref , 1}} - 1}{{D}_{2} - {D}_{1}} ,$$

D₁ being an initial background signal level, D₂ being the background signal level used for determining the correction function, D_{meas,i} being the background signal level of the measurement signal S_{meas,i}, S_{ref, 1} is a first reference signal having background level D₁, S_{ref, 2} is a second reference signal having background level D₂.
Embodiment 31: The method according to any one of the preceding embodiments referring to a method for determining at least one item of information, wherein the method is at least partially computer-implemented.
Embodiment 32: A non-transient computer-readable medium including instructions that, when executed by one or more processors, cause the one or more processors to perform at least one of the methods according to any one of the preceding method embodiments.
Embodiment 33: A photodetector for measuring optical radiation, the photodetector being configured for performing the method for determining at least one correction function for compensating for responsivity changes of at least one photodetector according to any one of the preceding embodiments referring to a method for determining at least one correction function for compensating for responsivity changes of at least one photodetector and/or for performing the method for determining at least one item of information on a measurement object according to any one of the preceding embodiments referring to a method for determining at least one item of information on a measurement object, wherein the photodetector comprises at least one photosensitive region and at least one readout electronics unit.
Embodiment 34: The photodetector according to the preceding embodiment, wherein the readout electronics unit comprises one or more of at least one bias voltage source, at least one operational amplifier; at least one analog-to-digital converter; at least one voltage divider; at least one current divider; an ASIC.
Embodiment 35: The photodetector according to any one of the preceding embodiments referring to a photodetector, wherein the photodetector further comprises at least one temperature stabilizing device.
Embodiment 36: The photodetector according to any one of the preceding embodiments referring to a photodetector, wherein the photosensitive region comprises at least one photoconductive material.
Embodiment 37: The photodetector according to the preceding embodiment, wherein the photoconductive material is selected from at least one of PbS, PbSe, Ge, InGaAs, InSb, and HgCdTe.
Embodiment 38: The photodetector according to any one of the preceding embodiments referring to a photodetector, wherein photodetector comprises at least one evaluation unit and/or comprises at least one interface for transmitting data from and/or to and/or within the evaluation unit.
Embodiment 39: The photodetector according to any one of the preceding embodiments referring to a photodetector, wherein the evaluation unit is at least partially cloud based.
Embodiment 40: A spectrometer for spectrally analyzing optical radiation provided by at least one measurement object, the spectrometer comprising:
   at least one radiation source configured for emitting optical radiation at least partially towards the measurement object; and
   at least one photodetector according to any one of the preceding embodiments referring to a photodetector.
Embodiment 41: The spectrometer according to the preceding embodiment, wherein the spectrometer further comprises at least one evaluation unit, wherein the evaluation unit is further configured for generating at least one item of spectral information on the measurement object.
Embodiment 42: The spectrometer according to the preceding embodiment, wherein the evaluation unit is further configured for controlling the radiation source.
Embodiment 43: The spectrometer according to any one of the preceding embodiments referring to a spectrometer, wherein the radiation source is a modulated radiation source.
Embodiment 44: The spectrometer according to any one of the preceding embodiments referring to a spectrometer, wherein the radiation source comprises at least one of a semiconductor-based radiation source and a thermal radiator.
Embodiment 45: The spectrometer according to any one of the preceding embodiments referring to a spectrometer, further comprising at least one optical filter element.
Embodiment 46: Use of a spectrometer according to any one of the preceding embodiments referring to a spectrometer for a purpose of use, selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 schematically shows an exemplary embodiment of a spectrometer according to the present invention;

FIGS. 2A-2B schematically show an exemplary embodiment of a photodetector according to the present invention;

FIG. 3 shows a flow chart of an exemplary embodiment of a method for determining at least one correction function for compensating for responsivity changes of at least one photodetector.

FIGS. 4A-5B show experimental results of measurements on an exemplary embodiment of a spectrometer according to the present invention; and

FIG. 6 shows a flow chart of an exemplary embodiment of a method for determining at least one item of information on a measurement object.

### DETAILED DESCRIPTION OF THE EMBODIMENTS

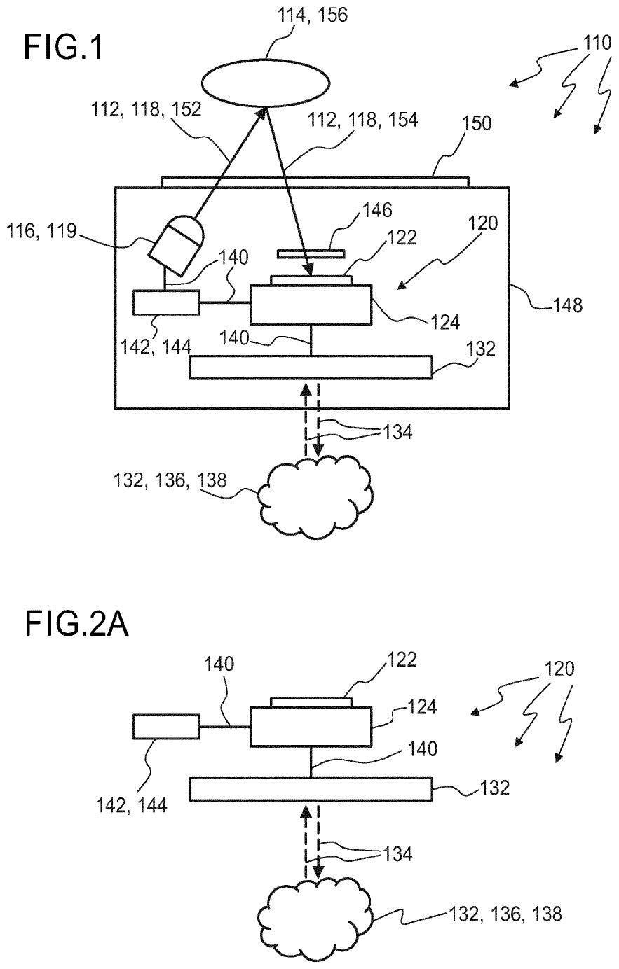

FIG. 1 schematically shows an exemplary embodiment of a spectrometer 110 according to the present invention. The spectrometer 110 is configured for spectrally analyzing optical radiation 112 provided by at least one measurement object 114. The spectrometer 110 may be an apparatus which is configured for determining spectral information by recording at least one measured value for at least one signal intensity related to at least one corresponding signal wavelength of the optical radiation 112 and by evaluating at least one detector signal which relates to the signal intensity. The measurement object 114 may be an arbitrary body, chosen from a living body and a non-living body. The measurement object 114 may specifically comprise at least one material which is subject to an investigation. The measurement object 114 may generally refer to an object which is to be measured, e.g. for which a spectrum is to be recorded, wherein the measurement object 114 may have in principle arbitrary properties, e.g. arbitrary optical properties or an arbitrary shape. The measurement object 114 may comprise at least one solid or fluid sample.

The spectrometer 110 comprises at least one radiation source 116 configured for emitting the optical radiation 112 at least partially towards the at least one measurement object 114. The radiation source 116 may be a device configured for emitting the optical radiation 112. The radiation source 116 may be configured for emitting the optical radiation 112 towards the measurement object 114, such as in form of a light beam 118 as indicated in FIG. 1. Alternatively or additionally, the radiation source 116 may be configured for isotopically emitting the optical radiation 112, e.g. uniformly in all spatial directions, wherein only a part of the emitted optical radiation 112 may impinge the measurement object 114. The radiation source 116 may comprise at least one of a semiconductor-based radiation source or a thermal radiator. The at least one semiconductor-based radiation source may be selected from at least one of a light emitting diode (LED) or a laser, specifically a laser diode. The LED may comprise at least one fluorescent and/or phosphorescent material. The thermal radiator may comprise at least one of an incandescent lamp, a black body emitter and a microelectromechanical system (MEMS) emitter. The radiation source 116 may be a modulated radiation source 119. Thus, the optical radiation 112 may be modulated. The modulating may comprise a process of changing, specifically periodically changing, at least one property of the optical radiation 112, specifically one or both of an intensity or a phase of the optical radiation 112. The modulation may be a full modulation from a maximum value to zero, or may be a partial modulation, from a maximum value to an intermediate value greater than zero.

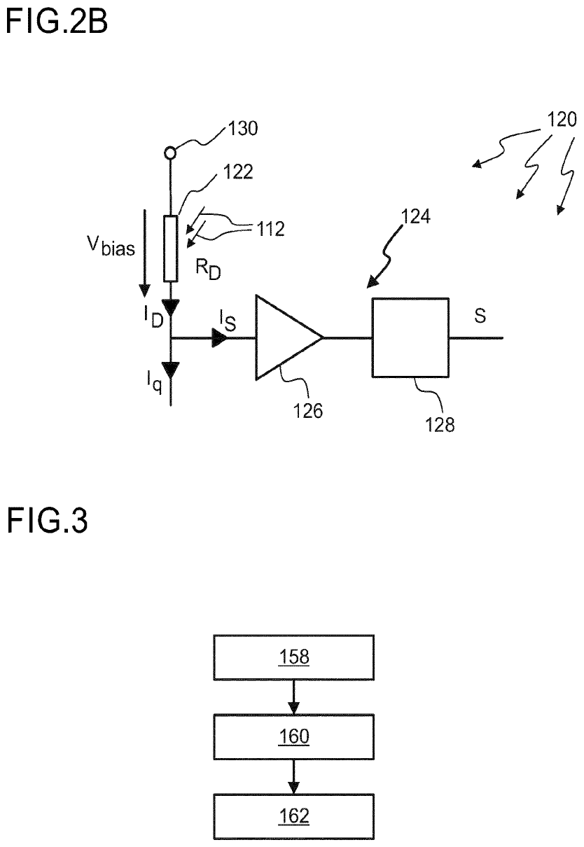

The spectrometer 110 comprises at least one photodetector 120 according to any one of the embodiments described above or below in further detail referring to the photodetector 120. With respect to the photodetector 120, reference may further be made to FIGS. 2A and 2B which schematically show an exemplary embodiment of the photodetector 120 according to the present invention in an isolated fashion. Specifically, FIG. 2A indicates a setup of the photodetector 120 and FIG. 2B indicates a circuit diagram corresponding to the photodetector 120. The photodetector 120 is configured for performing the method for determining at least one correction function for compensating for responsivity changes of at least one photodetector according to the present invention and/or for performing the method for determining at least one item of information on a measurement object according to the present invention. The photodetector 120 comprises at least one photosensitive region 122 and at least one readout electronics unit 124.

The photodetector 120 may be an optical detector or sensor configured for detecting the optical radiation 112, such as for detecting an illumination and/or a light spot generated by the at least one light beam 118. The photodetector 120 may comprise at least one substrate. A single photodetector 120 may be a substrate with at least one single photosensitive area 122, which generates a physical response to the illumination for a given wavelength range. The photodetector 120 may comprise a plurality of photosensitive regions 122, which may be arranged in at least one of an array or a matrix. The photosensitive region 122 may be a unit of the photodetector 120 configured for being illuminated, or in other words for receiving the optical radiation 112, and for generating at least one signal, such as an electronic signal, in response to the illumination. The photosensitive region 122 may be located on a surface of the photodetector 120. The photosensitive region 122 may specifically be a single, closed, uniform photosensitive region 122. The at least one photosensitive region 122 may comprise at least one photoconductive material. The photoconductive material may be selected from at least one of PbS, PbSe, Ge, InGaAs, InSb, or HgCdTe. The photosensitive region 122 may be configured as a photoconductor or photodiode. The photosensitive region 122 may be optically active. The photosensitive region 122 may generate an electrical signal when illuminated. An integrated circuit may condition, amplify and/or digitize an optically induced electrical signal.

The readout electronics unit 124 may be an electronics unit configured for quantifying and/or processing at least one physical property and/or a change in at least one physical property detected by the photodetector 120 or more specifically the photosensitive region 122. As indicated in FIG. 2B, the readout electronics unit 124 may comprise at least one of: an operational amplifier 126; an analog-to-digital converter 128; a voltage divider; a current divider, an ASIC, specifically for subtracting a constant current I_{q} for generating a signal current I_{S}. The photodetector 120 may comprise a bias voltage source 130. The bias voltage source 130 may be voltage source configured for generating the bias voltage. The bias voltage source 130 may be configured for applying at least one, e.g. constant, bias voltage V_{bias} to the photodetector 120, specifically to the photosensitive region 122 which may be regarded as a resistance in this context. A dark signal, in particular dark current I_{D}, may be generated by applying the bias voltage V_{bias} to the photosensitive region 122 by using the bias voltage source 130. A dark current I_{D} may flow through the photodetector 122 with I_{D}=V_{bias}/R_{D}, with V_{bias} being the bias voltage and R_{D} being the dark resistance. The readout electronics unit may be configured for subtracting a constant current I_{q} from the dark current I_{D} which results in the signal current I_{S}=I_{D}−I_{q}. The signal current Is may be amplified by front-end electronics, such as the operational amplifier 126, and a digital signal S may be generated afterwards using the analog-to-digital converter 128. Changes in V_{bias} can result in changes in responsivity changes which can be corrected by using the compensation method according to the present invention.

The compensation may be a cancellation or a correction of a physical effect, specifically of a disturbing influence or interference or perturbation. The compensation may be or may comprise a measure against the perturbation. Specifically, the compensation may be a temperature compensation, wherein the temperature, or more specifically temperature variations, may be a perturbation, e.g. for a detector. As an example, a responsivity of the photodetector 120 may be temperature dependent. Thus, variations of an environmental temperature of the photosensitive region 122 may lead to additional variations of the detector signal which are not responsive to an illumination of the photodetector 120. In other words, the detector signal may be subject to a temperature drift. The responsivity may comprise a relation between at least one input and at least one output of the photodetector 120. The responsivity may be a relation between an optical input and an electrical output. The responsivity may measure the electrical output, e.g. a photocurrent or a resistance, per optical input, e.g. an illumination intensity or irradiance. The responsivity may also be referred to as photosensitivity. A responsivity change may comprise any deviation in responsivity, e.g. relative to a pre-defined value and/or responsivity determined at a different point in time.

The at least one photodetector 120 or at least the spectrometer 110 may comprise at least one of an evaluation unit 132 or a communication interface 134 configured for transmitting data at least one of from or to or within the evaluation unit 132. Additionally or alternatively, the evaluation unit 132 may at least partially be arranged outside of the spectrometer 110, such as in an external device, e.g. a computer, a smartphone or a tablet. The evaluation unit 132 may be a device configured for analyzing or interpreting data, specifically for determining at least one item of qualitative or quantitative information. The information may specifically be obtained by evaluating at least one detector signal generated by the at least one photodetector 120. The evaluation unit 132 may be or may comprise at least one of an integrated circuit, in particular an application-specific integrated circuit (ASIC), or a data processing device, in particular at least one of a digital signal processor (DSP), a field programmable gate array (FPGA), a microcontroller, a microcomputer, a computer, or an electronic communication unit, specifically a smartphone or a tablet. Further components may be feasible, in particular at least one preprocessing device or data acquisition device. Further, the evaluation unit 132 may comprise at least one interface, in particular at least one of a wireless interface or a wire-bound interface. Further, the evaluation unit 132 can be designed to, completely or partially, control or drive further devices, such as the at least one photodetector 120 or the spectrometer 110 or parts thereof, such as the radiation source 116. The information as determined by the evaluation unit 132 may, in particular, be provided to at least one of a further apparatus, or to a user, preferably in at least one of an electronic, visual, acoustic, or tactile fashion. Further, the information may be stored in at least one data storage unit, specifically in an internal data storage unit as comprised by the photodetector 120 or at least the spectrometer 110, in particular by the at least one evaluation unit 132, or in an separate storage unit to which the information may be transmitted via the at least one interface. The separate storage unit may be comprised by the at least one electronic communication unit. The storage unit may in particular be configured for storing at least one electronic table, such as at least one look-up table.

The evaluation unit may 132, preferably, be configured to perform at least one computer program, in particular at least one computer program performing or supporting the steps of the methods according to the present invention. For this purpose, the evaluation unit 132 may, particularly, comprise at least one data processing device, in particular at least one of an electronic or an optical data processing device. The processing device may be designed for determining of the correction function.

The at least one evaluation unit 132 may be at least partially cloud-based. In other words, the at least one evaluation unit 132 may at least partially be distributed in at least one cloud 136 used for at least one of cloud computing or cloud storage. The at least one cloud 134 may specifically comprise at least one external device 138, e.g. a computer or a computer network. As shown in FIGS. 1 and 2A, the at least one evaluation unit 132 may at least partially be distributed within the photodetector 120, e.g. for a first signal processing of the detector signal read out by the at least one readout electronics unit 124, such as for a signal filtering or a signal smoothening. Further signal processing or signal evaluation may be performed in a part of the at least one evaluation unit 132 distributed over the at least one external device 138 of the at least one cloud 136. The at least one external device 138 may specifically comprise more computing power or data storage volume. Additionally or alternatively, the at least one external device 138 may be more user-friendly or mobile, such as a smart phone. The external devices 138 may be arbitrarily spatially distributed. The external devices 138 may vary over time, specifically on demand. The external devices 138 may be interconnected by using the internet or an intranet. The different parts of the at least one evaluation unit 132 may at least partially be interconnected by the at least one communication interface 134. The communication interface 134 may be at least one of wireless or wire-bound.

The communication interface 134 may be an item or element forming a boundary configured for transferring information. In particular, the communication interface 134 may be configured for transferring information from a computational device, e.g. a computer, such as to send or output information, e.g. onto another device. Additionally or alternatively, the communication interface 134 may be configured for transferring information onto a computational device, e.g. onto a computer, such as to receive information. The communication interface 134 may specifically provide means for transferring or exchanging information. In particular, the communication interface 134 may provide a data transfer connection, e.g. Bluetooth, NFC, inductive coupling or the like. As an example, the communication interface 134 may be or may comprise at least one port comprising one or more of a network or internet port, a USB-port and a disk drive. The communication interface 134 may comprise at least one web interface. The at least one readout electronics unit 124 may be wired to at least one of the at least one evaluation unit or the at least one communication interface 134, such as by using a wire 140.

The photodetector 120 may further comprise at least one temperature stabilizing device 142. The temperature stabilizing device 142 may be an element or device configured for keeping a temperature of a further element or device constant or steady or stable. Specifically, the at least one temperature stabilizing device 142 may be configured for stabilizing the temperature of the photodetector 120. The temperature stabilizing device 142 may be configured for keeping the temperature of components of the photodetector 120 such as the photosensitive region 122 and/or the readout electronics unit 124 at a predetermined level. The temperature stabilizing device 142 may be configured for stabilizing the temperature of components of the photodetector 120 such as the photosensitive region 122 and/or the readout electronics unit 124. The temperature stabilizing device 142 may be configured for stabilizing the temperature of further components of the spectrometer 110, specifically of the radiation source 116. The temperature stabilizing device 142 may be wired to at least one of the photodetector and the radiation source 116. The temperature stabilizing device 142 may be or comprise at last one thermoelectric cooler 144. The thermoelectric cooler 144 may be an electrically driven heat pump configured for transferring heat between at least two spatial areas, thereby generating a heat flux between the at least two spatial areas. The thermoelectric cooler 144 may, specifically, be based on the Peltier effect in order to create the heat flux. For this purpose, the thermoelectric cooler 144 may, especially, comprise at least one Peltier element. A direction of the heat flux may depend on a direction of an electrical current applied to the thermoelectric cooler 144. Depending on the direction of the heat flux, the thermoelectric cooler 144 can be used for cooling at least one spatial area by transferring heat to at least one further spatial area, or for heating the spatial area by transferring heat from the at least one further spatial area.

The spectrometer 110 may further comprise at least one optical filter element 146 configured for filtering the optical radiation 112 or more specifically selected wavelengths of the optical radiation 112. The at least one optical filter element may specifically be positioned in a beam path before the photosensitive region 122. The spectrometer 110 may comprise a plurality of photodetectors 120, each comprising one or more photosensitive regions 122, and a plurality of optical filter elements 146. The optical filter element 146 may be positioned in a beam path before at least one photodetector 120, wherein the plurality of optical filter elements 146 may be configured for at least partially filtering different wavelengths. The spectrometer 110 may further comprise at least one housing 148 surrounding at least parts of the spectrometer 110, such as the photodetector 120 and/or the radiation source 116. The external device 138 of the cloud 134 may be arranged outside of the housing 148. The housing 142 may comprise at least one window 150. The at least one window 150 may at least partially be transparent for the optical radiation 112.

In the following, an exemplary beam path of the optical radiation 112 will be described with respect to FIG. 1. The at least one radiation source 116 may emit the optical radiation 112 as incident optical radiation 152 through the window 150 towards the measurement object 114. The measurement object 114 may at least partially, specifically diffusely, reflect the incident optical radiation 152 towards the photosensitive region 122 of the photodetector 120 in form of reflected optical radiation 154. Further, the measurement object 114 may at least partially absorb the incident optical radiation 152, which may be indicative of at least one physical property or chemical composition of the measurement object 114. The reflected optical radiation 154 may pass the window 150 and the optical filter element 146 before reaching the photodetector 120, which may generate a corresponding signal. In the described beam path, the measurement object 114 may easily be replaced by a reference 156 having known optical properties, as e.g. typically used for calibration purposes. Generally, the reference 156 may be an arbitrary object. Specifically, the reference 156 may have at least one known physical property, in particular at least one optical property. However, the reference 156 may for example also have unknown physical properties. For example, the reference 156 may be a sample to be measured such as the measurement object 114.

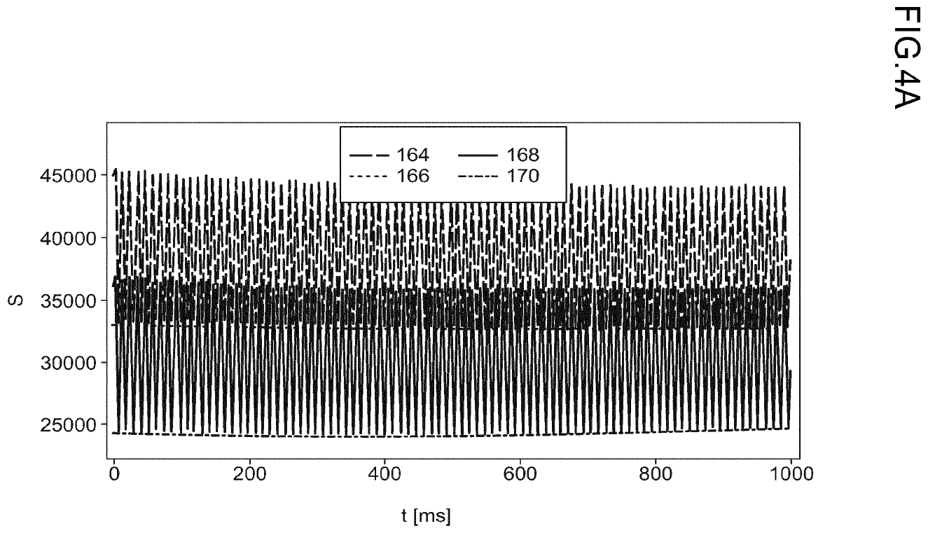

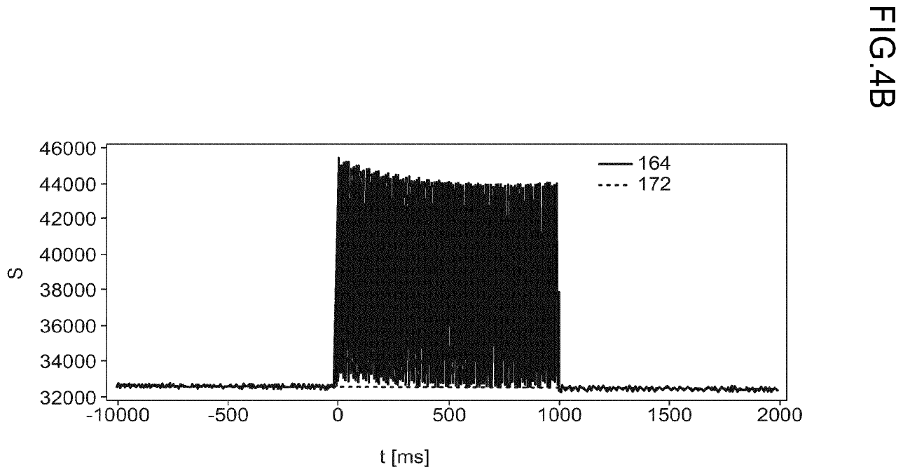

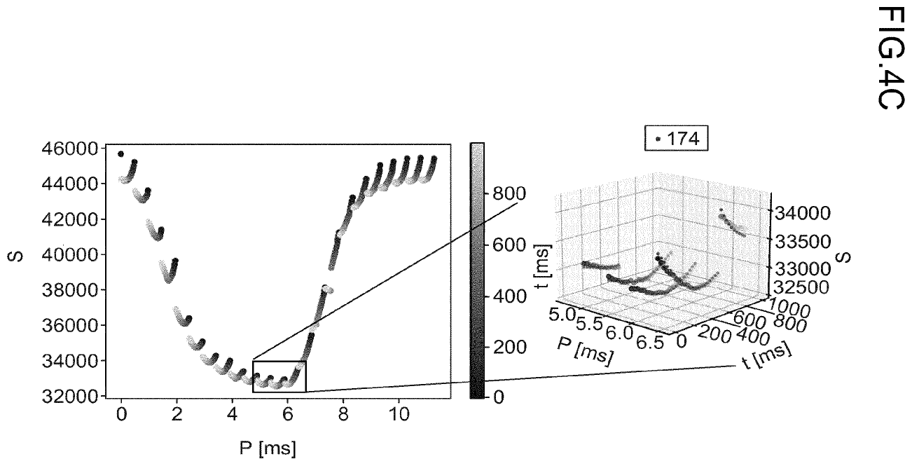

FIG. 3 shows a flow chart of an exemplary embodiment of a method for determining at least one correction function for compensating for responsivity changes of the photodetector 120. The photodetector 120 comprises the photosensitive region 122 and the readout electronics unit 124 for reading out the photosensitive region 122. The method comprises the following steps:
a) (denoted with reference number 158) determining at least one reference signal of the photodetector 120, wherein the photosensitive region 122 is illuminated by the optical radiation 112 provided by at least one reference 156 for determining the reference signal;
b) (denoted with reference number 160) determining at least one background signal level of the photodetector 120;
c) (denoted with reference number 162) determining the correction function by using at least one evaluation unit 132, wherein the determining of the correction function comprises determining a change in background signal level and evaluating a relationship of the change in background signal level and the reference signal.

The method steps a) to c) may be performed in the indicated order. It shall be noted, however, that a different order is also possible. The method may comprise further method steps which are not listed. Further, one or more of the method steps a) to c) may be performed once or repeatedly. Further, two or more of the method steps a) to c) may be performed simultaneously or in a timely overlapping fashion. The method may comprise repeating steps a) to c) at pre-defined times or continuously.

The method for determining at least one correction function for compensating for responsivity changes of the photodetector 120 may at least partially be computer-implemented. A computer-implemented method may be a method involving at least one computer and/or at least one computer network. The computer and/or computer network may comprise at least one processor which is configured for performing at least one of the method steps of the method according to the present invention. Specifically, each of the method steps is performed by the computer and/or computer network. The method may be performed completely automatically, specifically without user interaction.

The method may comprise compensating a change of the responsivity of the photosensitive region 122 caused by a physical quantity affecting a resistance, specifically a dark resistance, of the photosensitive region 122. The method may comprise compensating a change of the responsivity of the photosensitive region 122 caused by at least one of: a change of a temperature of the photosensitive region 122; a change of an illumination of the photosensitive region 122, specifically by at least one background radiation; a change of a temperature of the evaluation unit 132 or at least parts thereof; a change of at least one physical quantity, specifically of a temperature, of the photodetector 120 or at least of parts thereof, specifically of at least one optional further electronic component of the photodetector 120 as described above or as described in more detail below.

The reference signal may be a signal generated by the photodetector 120 in response to illumination by the optical radiation 112 provided by the reference 156. Specifically, the reference signal may be generated by the photosensitive region 122 in response to illumination. The reference signal may be or comprise at least one signal generated at a single point in time. The reference signal may be or comprise at least one signal generated over a time period. The reference signal may be or comprise at least one preprocessed signal, such as a filtered or smoothened or amplified signal. The reference signal may be or comprise at least one of an analog signal or a digital signal.

Step a) may comprise determining a plurality of reference signals. For example, reference signals may be determined for different conditions of the photodetector 120, in particular for one or more of different temperatures of the photosensitive region 122; different illumination of the photosensitive region 122; different temperatures of the evaluation unit 132 or at least parts thereof; different physical quantities of the photodetector 120 or at least of parts thereof, specifically of at least one optional further electronic component of the photodetector described above or below in further detail, different bias voltage. The reference signals may be determined at different times. For example, reference signals may be determined for different pre-defined temperatures.

The reference signal may be measured online during sample measurement using frequency multiplexing and/or by measuring the reference signal throughout at least one extended time period without sample measurement. For example, for sample measurement and measurement of the reference signal different frequencies may be used. For example, the optical radiation in step a) may be modulated. Additionally or alternatively, the reference signal may be measured before or after sample measurement.

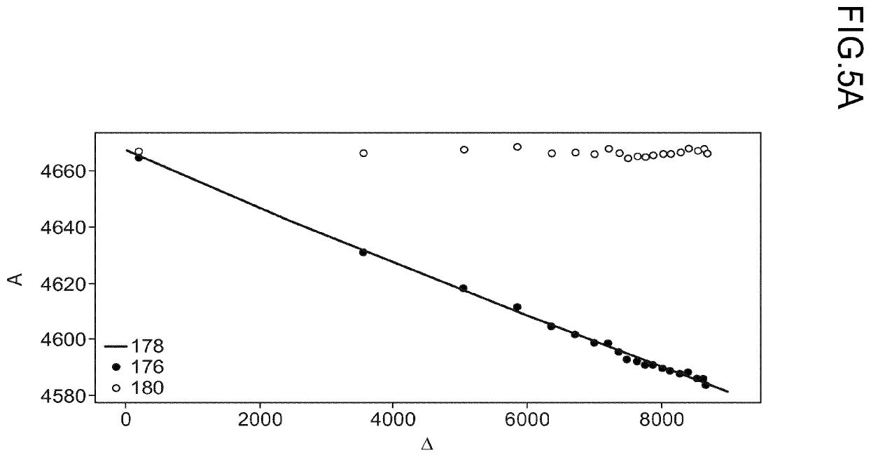

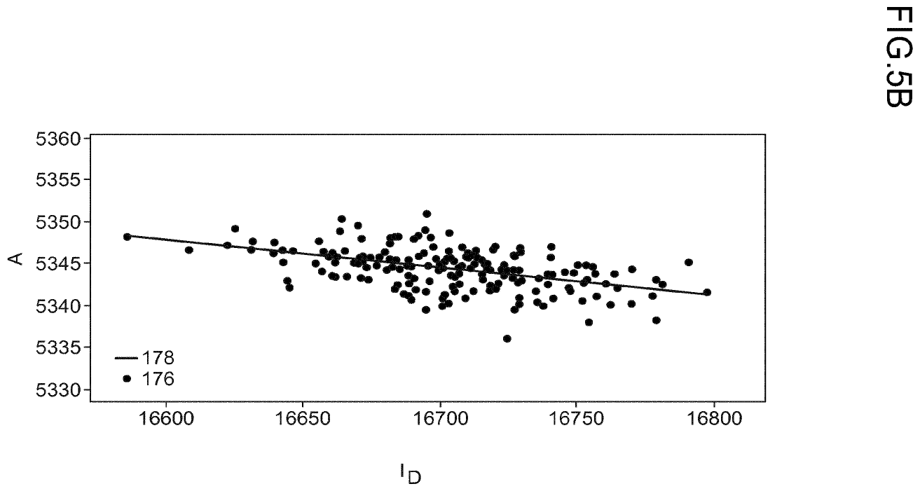

FIGS. 4A-5B show experimental results of measurements on an exemplary embodiment of the spectrometer 110. FIG. 4A shows a signal trace of a modulated reference signal at two different detector temperatures over a time t of 1000 ms. The signals S are digitally recorded in counts. Dark currents are extracted from the dark phases and extrapolated for the light phases as will be described in further detail below. A modulated reference signal at a photodetector temperature of 21.927° C. is denoted with reference number 164. A corresponding modeled background signal at a photodetector temperature of 21.927° C. is denoted by reference number 166. A modulated reference signal at a photodetector temperature of 21.543° C. is denoted with reference number 168. A corresponding modeled background signal at a photodetector temperature of 21.543° C. is denoted with reference number 170. As can be seen, the difference in photodetector temperature reflects in a difference in the modeled background signals 168 and 170. In FIG. 4B, a background signal model of the modulated reference signal 164 is developed by using the time intervals before and after the modulated reference signal 164 is recorded. The corresponding further modeled background signal at a photodetector temperature of 21.927° C. is denoted with reference number 172.

A background signal may be a signal generated by the photodetector 120 independent of an illumination. For example, for determining the background signal, the photosensitive region 122 may be covered by at least one opaque cover and/or unilluminated. As an example and as indicated in FIG. 4A, the photosensitive region may be unilluminated, at least for pre-defined time intervals, when using modulated optical radiation. The modulation may be a full modulation down to zero intensity, such that the photosensitive region 122 may be unilluminated in a minimum of the intensity of the modulated optical radiation. For example, without being illuminated, the photosensitive region 122 may be configured for generating the background signal. The background signal may be a signal generated by the photosensitive region 122, wherein an illumination of the photosensitive region 122 is inhibited when generating the background signal.

The background signal may be dependent on at least one intrinsic property of the photosensitive region 122, specifically a material property of at least one semiconductor comprised by the photosensitive region 122. The background signal may specifically be dependent on a temperature of the photosensitive region 122. The background signal may comprise a dark signal, in particular a dark current. The dark current may be thermally induced by a spontaneous formation of free charge carriers within a semiconductor of the photosensitive region 122.

A background signal level may be a mean of minima of the background signal. In step a), the optical radiation 112 may be modulated. The background signal level may be determined by using times and phase of minima of the modulated optical radiation 112. The determining of the background signal level may comprise extrapolating dark signals and/or modeling the dark signals. For example, dark signals may be extracted only from the dark phases. The extrapolating may comprise extrapolating to times in which the background signal is not determined, e.g. during illumination of the photosensitive region e.g. during determining of the reference signal and/or during sample measurement. The modeling of the measured dark signals may comprise fitting the measured dark signals, e.g. using a pre-defined fitting function on the identified minima. For example, the pre-defined fitting function may be a linear function.

The method may comprise measuring, in particular both of, the reference signal and the background signal under at least two different conditions of the photodetector 120. The conditions of the photodetector 120 may be set by setting and/or adjusting a value of at least one influencing variable. The influencing variable may be at least one variable affecting a dark resistance of the photosensitive region 122. The influencing variable may be at least one variable selected from the group consisting of: a temperature of the photosensitive region 122; an illumination of the photosensitive region 122; a temperature of the evaluation unit 132 or at least parts thereof; at least one physical quantity of the photodetector 120 or at least of parts thereof, specifically of at least one optional further electronic component of the photodetector 120 described above or below in further detail, a bias voltage.

The background signal level and the reference signal may be measured timely coincident, such that determining of the reference signal and dark signals may be performed in one and the same measurement and/or at the same time. Measuring timely coincident may be possible by using not only time information of a timely coincident measured signal but, in addition, phase information. FIG. 4C shows the modulated reference signal 164 as phased signal curve, wherein the phase P is measured in ms. From the phased signal curve, specifically from the indicated interval around a phase of 6 ms, a background signal model 174 is derived. The timely coincident measured signal S can be describe as a composite polynomial S(phase, t)=P1(phase)+P2(t), where P1 and P2 are polynomials as a function of the phase and time, respectively. P1 may be chosen such that it reaches 0 at the phase of minimum signal; then, P2 describes the dark signal with time such that the dark signal can be modelled. The method may comprise considering the complete coincident measured signal or only parts of the coincident measured signal. For example, parts of the coincident measured signal about a predefined limit, e.g. about ±1 ms, away from a minimum phase may be used of the dark signal modelling. The optimization of the problem and analytical description for dark signal modelling may depend on one or more of a modulation form, frequency, and signal decay time, as well as the used light source. Measuring timely coincident may allow online calibration, i.e. during operation of the photodetector 120. Measuring timely coincident may allow preventing the need of additional calibration times, and therefore enhancing measurement efficiency.

For example, the determining of the background signal level in step b) may comprise determining dark signals from dark phases during determining of the reference signal. A dark phase may be a time range in which the photosensitive region is covered by at least one opaque cover and/or is unilluminated. For example, dark signals may be extracted from the dark phases and may be extrapolated for the phases where illumination is incident on the photosensitive region 122. For example, the background signal level and the reference signal may be measured at different times. For example, step b) may comprise determining dark signals before and/or between and/or after determining of the reference signal.

The method may use the dark current together with a, not necessarily timely coincident, reference signal to correct for responsivity changes. As outlined above, determining of dark signals can be performed during dark phases such that no additional measurements before and/or after a sample measurement are necessary. This may allow that even small scale variations, i.e. time scales lower than a measurement time, are trackable. In addition, the method may comprise determining dark signals before and/or between and/or after modulated measurements such that dark signals are determined in the truly dark for the entire measurement period. The determining of coefficients of the correction functions can be performed by actively tracking the reference signal and dark signals in an online fashion. This can be achieved either through frequency multiplexing or by tracking the reference throughout extended time periods, where no sample measurement is obtained.

FIG. 5A indicates a reference signal level corresponding to the modulated reference signal 164 plotted over modeled changes Δ in the background signal. The reference signal level is specifically indicated by means of raw amplitudes 176 obtained via fast Fourier transform at the modulation frequency. A correction function, denoted with reference number 178, is fit thereto for obtaining corresponding corrected amplitudes 180. The amplitudes A and the modeled changes Δ are again represented in counts. FIG. 5B analogously indicates the case of a temperature-stabilized photodetector 120. Even in this case signal drifts are visible and typically caused by electronic drifts. In FIG. 5B, the amplitudes A are directly plotted over a dark current I_{D} measured in counts.

The correction function may be a mathematical function for compensating for responsivity changes of the photodetector 120. The correction function may comprise at least one coefficient. The correction function may be a function selected from the group consisting of: a linear function; a polynomial function; an exponential function. The correction function 178 may be applied for correcting any measured signal (including sample measurements) at its corresponding dark signal level.

The determining of the correction function comprises determining a change in background signal level. The method according to the present invention may comprise retrieving at least one initial background signal level. The retrieving of the initial background signal level may comprise measuring and/or using a pre-defined, e.g. stored value such as a value retrieved from a lookup table. For example, the initial background level may be a background level at a pre-defined reference temperature e.g. at 20° C. The determining of the change in background signal level comprises comparing the initial background signal level and the background signal level determined in step b).

The determining of the correction function comprises evaluating a relationship of the change in background signal level and the reference signal. The change of the background signal level may be determined relative to the reference signal that corresponds to a zero-point of the dark signal change. The correction function may be determined by fitting the correction function to the relationship of the change of background signal level and the reference signal, thereby determining the parameters of the correction function. The correction function may be fit to the relationship of reference signal vs. modeled changes in the dark signal. For example, the correction function is a linear function

$${S}_{i} = \frac{( {S}_{ref , 2} - {S}_{ref , 1} )}{( {D}_{2} - {D}_{1} )} ( {D}_{i} - {D}_{1} ) + {S}_{ref , 1} ,$$

wherein S_{ref, 1} is a first reference signal having background level D₁, S_{ref, 2} is a second reference signal having background level D₂.

For example, the method may be used for compensating for systematic changes in dark resistance. Any change in dark resistance can result in a change in the dark current and therefore a change in signal current will be seen. A change in dark resistance may be caused by a change in the detector temperature but also by background light or any other quantity that may affect the resistance of the photodetector 120 itself. In fact, the method according to the present invention may allow for a universal correction scheme for all means of resistance changes. Further, any signals or currents originated by an optical signal on the photodetector 120 can be obtained since those also impact the detector's resistance. The optical signal may be modulated in order to enable efficient signal processing that distinguishes the signal from the dark signal and the noise, and systematic drifts. Longterm stability may change with time but using defined reference signal level, an online calibration may be feasible by using the method according to the present invention. The background signal level and reference signal may be determined in modulated manner and/or during a sample measurement by monitoring the dark phases, e.g. either before/after a sample measurement. A change in responsivity (photosensitivity) can be determined from the change in the dark signal/current as monitored by the (change in) reference signal. In order to obtain more precise calibrations, repeated calibration measurements may be acquired.

For example, the method according to the present invention may be used for compensating for systematic drifts in the current I_{q} and/or the bias voltage V_{bias}, in particular in case of using a stabilized detector. The dark resistance may be kept stable by means of, e.g., the thermoelectric cooler 144. The systematic drifts may be, for example, caused by environmental condition variations such as changes in the temperature of electronic components other than the photodetector 120 itself. Under the condition that the dark resistance is constant, any change in I_{q} or I_{D} (i.e., originated from a change in V_{bias}) may result in a change in Is and therefore in the digital signal S. For photoresistors, the responsivity may be given by fundamental detector characteristics and the applied bias voltage V_{bias}. Hence, changes in V_{bias} may result in changes of the responsivity. Therefore, the method according to the present invention may be also applied to compensate such systematic drifts in electronics as the changes are mapped in the dark signal.

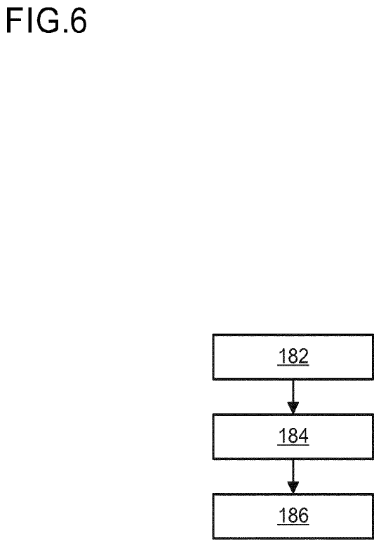

FIG. 6 shows a flow chart of an exemplary embodiment of a method for determining at least one item of information on the measurement object 114 using the photodetector 120. The photodetector 120 comprises the photosensitive region 122 and the readout electronics unit 124 for reading out the photosensitive region 122. The method comprises the following steps:
i) (denoted with reference number 182) providing the optical radiation 112 by the measurement object 114 and determining at least one measurement signal by using the photodetector 120;
ii) (denoted with reference number 184) correcting the measurement signal by using a correction function by using the evaluation unit 132, wherein the correction function is determined by using the method for determining at least one correction function according to the present invention; and
iii) (denoted with reference number 186) determining the item of information on the measurement object 114 by evaluating the corrected measurement signal by using the evaluation unit 132.

The method steps i)-iii) may be performed in the indicated order. It shall be noted, however, that a different order is also possible. The method may comprise further method steps which are not listed. Further, one or more of the method steps i)-iii) may be performed once or repeatedly. Further, two or more of the method steps i)-iii) may be performed simultaneously or in a timely overlapping fashion.

The item of measurement information may be knowledge or evidence providing a qualitative and/or quantitative description relating to at least one measurement, specifically to the measurement object 114. The item of measurement information may comprise at least one of a physical property of the measurement object 114 or a chemical composition of the measurement object 114. The physical property may specifically comprise an optical property such at least one absorbance of the measurement object 114 and/or at least one emissivity of the measurement object 114. The chemical composition may specifically refer to qualitative and/or quantitative information on at least one material the measurement object 114 comprises.

In step i), the optical radiation 112 provided by the at least one measurement object 114 may comprise a wavelength of 300 nm to 3000 nm, specifically 500 nm to 2500 nm, more specifically 1400 nm to 2000 nm. The providing may comprise at least one of reflecting, specifically diffusely; diffracting; transmitting and emitting the optical radiation 112. The optical radiation 112 provided by the measurement object 114 may be indicative of at least one of a physical property of the measurement object 114, e.g. an optical property and/or a temperature of the measurement object 114, and a chemical property of the measurement object 114, e.g. a chemical composition of the measurement object 114. As an example, the optical radiation 112 provided by the measurement object 114 may be emitted by the at least one measurement object 114, specifically at least partially towards the photodetector 120. Further, the optical radiation 112 provided by the at least one measurement object 114 may be reflected by the at least one measurement object 114 at least partially towards the at least one photodetector 120, e.g. diffusely. Further, the optical radiation 112 provided by the at least one measurement object 114 may be transmitted through the at least one measurement object 114 at least partially towards the at least one photodetector 120. However, the at least one measurement object 114 may also at least partially absorb the optical radiation 112, which may specifically be indicative of at least one physical property of the at least one measurement object 114 and/or at least one chemical property of the at least one measurement object 114 such as a chemical composition of at least one material forming the at least one measurement object 114.

Step ii) comprises correcting the measurement signal by using a correction function by using the evaluation unit 132. The correction function is determined by using the method for determining at least one correction function according to the present invention. For further details regarding to the method for determining at least one item of measurement information, reference may be made to the description of the method for determining at least one correction function as described above or in more detail below.

Step iii) comprises determining the item of information on the measurement object 114 by evaluating the corrected measurement signal by using the evaluation unit 132. For example, the correction function is a linear function, wherein an i^{th} measurement signal S_{meas,i} is corrected into a corrected signal S_{corr,i} by

$${S}_{corr , i} = \frac{{S}_{meas , i}}{c \cdot ( ( {D}_{meas , i} - {D}_{1} ) + 1 )} ,$$

$$with$$

$$c = \frac{\frac{{S}_{ref , 2}}{{S}_{ref , 1}} - 1}{{D}_{2} - {D}_{1}} ,$$

D₁ being an initial background signal level, D₂ being the background signal level used for determining the correction function, D_{meas,i} being the background signal level of the measurement signal S_{meas,i}, S_{ref, 1} is a first reference signal having background level D₁, S_{ref, 2} is a second reference signal having background level D₂.

The method for determining at least one item of measurement information may at least partially be computer-implemented. Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

### LIST OF REFERENCE NUMBERS

110 spectrometer
112 optical radiation
114 measurement object
116 radiation source
118 light beam
119 modulated radiation source
120 photodetector
122 photosensitive region
124 readout electronics unit
126 operational amplifier
128 analog-to-digital converter
130 bias voltage source
132 evaluation unit
134 communication interface
136 cloud
138 external device
140 wire
142 temperature stabilizing device
144 thermoelectric cooler
146 optical filter element
148 housing
150 window
152 incident optical radiation
154 reflected optical radiation
156 reference
158 method step a)
160 method step b)
162 method step c)
164 modulated reference signal at photodetector temperature of 21.927° C.
166 modeled background signal at photodetector temperature of 21.927° C.
168 modulated reference signal at photodetector temperature of 21.543° C.
170 modeled background signal at photodetector temperature of 21.543° C.
172 further modeled background signal at photodetector temperature of 21.927° C.
174 background signal model based on phased signal curve
176 raw amplitudes
178 correction function fit to raw amplitudes
180 corrected amplitudes
182 method step i)
184 method step ii)
186 method step iii)

1. A method for determining at least one correction function for compensating for responsivity changes of at least one photodetector, wherein the photodetector comprises at least one photosensitive region and at least one readout electronics unit for reading out the photosensitive region, the method comprising the following steps:
a) determining at least one reference signal of the photodetector, wherein the photosensitive region is illuminated by optical radiation provided by at least one reference for determining the reference signal;
b) determining at least one background signal level of the photodetector; and
c) determining the correction function by using at least one evaluation unit, wherein the determining of the correction function comprises determining a change in background signal level and evaluating a relationship of the change in background signal level and the reference signal.

2. The method according to claim 1, wherein the background signal level and the reference signal are measured timely coincident, wherein measuring timely coincident comprises determining of the reference signal and the background signal level in one and the same measurement and/or at the same time.

3. The method according to claim 1, wherein the reference signal is measured online during sample measurement using frequency multiplexing and/or by measuring the reference signal throughout at least one extended time period without sample measurement.

4. The method according to claim 1, wherein the determining of the background signal level in step b) comprises determining dark signals from dark phases during determining of the reference signal.

5. The method according to claim 1, wherein step b) comprises determining dark signals before and/or between and/or after determining of the reference signal.

6. The method according to claim 1, wherein, in step a), the optical radiation is modulated, wherein the background signal level is determined by using times and phase of minima of the modulated optical radiation.

7. The method according to claim 1, wherein the method comprises measuring the reference signal and the background signal under at least two different conditions of the photodetector, wherein the conditions of the photodetector are set by setting and/or adjusting a value of at least one influencing variable, wherein the influencing variable is at least one variable affecting a dark resistance of the photosensitive region, wherein the influencing variable is at least one variable selected from the group consisting of: a temperature of the photosensitive region; an illumination of the photosensitive region; a temperature of the evaluation unit or at least parts thereof; at least one physical quantity of the photodetector or at least of parts thereof, and a bias voltage.

8. The method according to claim 1, wherein the correction function is fit to the relationship of the change of background signal level and the reference signal.

9. The method according to claim 1, wherein the correction function is a linear function
$${S}_{i} = \frac{( {S}_{ref , 2} - {S}_{ref , 1} )}{( {D}_{2} - {D}_{1} )} ( {D}_{i} - {D}_{1} ) + {S}_{ref , 1} ,$$
wherein S_{ref, 1} is a first reference signal having background level D₁, S_{ref, 2} is a second reference signal having background level D₂.

10. A method for determining at least one item of information on at least one measurement object using at least one photodetector, wherein the photodetector comprises at least one photosensitive region and at least one readout electronics unit for reading out the photosensitive region, the method comprising the following steps:
i) providing optical radiation by the measurement object and determining at least one measurement signal by using the photodetector;
ii) correcting the measurement signal by using a correction function by using at least one evaluation unit, wherein the correction function is determined by using the method according to claim 1; and
iii) determining the item of information on the measurement object by evaluating the corrected measurement signal by using the evaluation unit.

11. The method according to claim 10, wherein the correction function is a linear function, wherein an i^{th} measurement signal S_{meas,i} is corrected into a corrected signal S_{corr,i} by
$${S}_{corr , i} = \frac{{S}_{meas , i}}{c \cdot ( ( {D}_{meas , i} - {D}_{1} ) + 1 )} ,$$
$$with$$
$$c = \frac{\frac{{S}_{ref , 2}}{{S}_{ref , 1}} - 1}{{D}_{2} - {D}_{1}} ,$$
D₁ being an initial background signal level, D₂ being the background signal level used for determining the correction function, D_{meas,i} being the background signal level of the measurement signal S_{meas,i}, S_{ref, 1} is a first reference signal having background level D₁, S_{ref, 2} is a second reference signal having background level D₂.

12. A non-transient computer-readable medium including instructions that, when executed by one or more processors, cause the one or more processors to perform the method according to claim 1.

13. A photodetector for measuring optical radiation, the photodetector being configured for performing the method according to claim 1, wherein the photodetector comprises at least one photosensitive region and at least one readout electronics unit.

14. A spectrometer for spectrally analyzing optical radiation provided by at least one measurement object, the spectrometer comprising:
at least one radiation source configured for emitting optical radiation at least partially towards the measurement object; and
at least one photodetector according to claim 13.

15. A method of using the spectrometer according to claim 14, the method comprising using the spectrometer for a purpose of use selected from the group consisting of an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; and a food analysis application.

16. A non-transient computer-readable medium including instructions that, when executed by one or more processors, cause the one or more processors to perform the method according to claim 10.

17. A photodetector for measuring optical radiation, the photodetector being configured for performing the method according to claim 10, wherein the photodetector comprises at least one photosensitive region and at least one readout electronics unit.

18. A spectrometer for spectrally analyzing optical radiation provided by at least one measurement object, the spectrometer comprising:
at least one radiation source configured for emitting optical radiation at least partially towards the measurement object; and
at least one photodetector according to claim 17.

19. A method of using the spectrometer according to claim 18, the method comprising using the spectrometer for a purpose of use selected from the group consisting of an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; and a food analysis application.
